(19) United States
(12) Patent Application Publication
(10) Pub. No.: US 2023/0322424 A1
(43) Pub. Date: Oct. 12, 2023

(54) PACKAGE RECEIVING OR PASSING APPARATUS, AND PACKAGE RECEIVING OR PASSING METHOD

(71) Applicant: DAIWA KASEI INDUSTRY CO.,LTD., Okazaki-shi (JP)

(72) Inventors: Haruhisa KAMIYA, Okazaki-shi (JP); Toshio IWAHARA, Okazaki-shi (JP)

(21) Appl. No.: 18/297,129

(22) Filed: Apr. 7, 2023

(30) Foreign Application Priority Data
Apr. 12, 2022 (JP) 2022-065478

(51) Int. Cl. B64U 40/20; B64U 20/70; B64U 50/30

(52) U.S. Cl. CPC B64U 40/20; B64U 20/70; B64U 50/30; B64U 2101/66

(57) ABSTRACT

Provided is an apparatus or a method that can stabilize flight of an unmanned aerial vehicle after package receiving or package passing. A port as a package receiving or passing apparatus includes: a landing portion on which an aerial vehicle lands; a slider for horizontally moving the landed aerial vehicle to an indoor area; an elevating/lowering portion on which a package-chamber tray taken down from the aerial vehicle in the indoor area is to be placed; a movement control portion for elevating/lowering an elevating/lowering portion; a package moving portion for moving a package between a package storage portion and the package-chamber tray placed on the elevating/lowering portion; and a center of gravity adjustment portion for adjusting the center of gravity position of the aerial vehicle after package receiving or package passing.

### REFERENCE TO RELATED APPLICATION

This application claims priority on Japanese Patent Application No. 2022-65478 filed on Apr. 12, 2022, the entire contents of which are incorporated herein by reference.

### BACKGROUND OF THE INVENTION

### Field of the Invention

This disclosure relates to an apparatus or a method for receiving a package transported by an unmanned aerial vehicle or passing a package to the unmanned aerial vehicle.

### Description of Related Art

Conventionally, it has been proposed that a package is transported using an unmanned aerial vehicle (also called a drone) (see, for example, Japanese Laid-Open Patent Publication No. 2021-8270, WO2020/136742, and Japanese Patent No. 6357602). For example, Japanese Laid-Open Patent Publication No. 2021-8270 proposes technology of moving a battery in a direction at a predetermined angle during flight, to improve flight efficiency of an aerial vehicle to which a package is mounted. WO2020/136742 proposes a package receiving and storing apparatus and a method for receiving and storing a package delivered by an unmanned aerial vehicle. Japanese Patent No. 6357602 proposes technology in which a battery to be mounted is selected on the basis of location information about a delivery destination of a package, weight information of the package, center of gravity information when a package is placed at the unmanned aerial vehicle, and the like.

In a case of receiving a package mounted to an unmanned aerial vehicle or passing a package to the unmanned aerial vehicle, the weight balance of the unmanned aerial vehicle changes between before and after package receiving or package passing, so that flight of the unmanned aerial vehicle after package receiving or package passing might become unstable.

Accordingly, an object of this disclosure is to provide an apparatus or a method that can stabilize flight of an unmanned aerial vehicle after package receiving or package passing.

### SUMMARY OF THE INVENTION

A package receiving or passing apparatus of this disclosure includes: a landing portion on which an unmanned aerial vehicle lands; a package storage portion; a conveyance portion configured to convey a package from the unmanned aerial vehicle landed on the landing portion to the package storage portion, or from the package storage portion to the unmanned aerial vehicle; a center of gravity adjustment portion configured to adjust a center of gravity position of the unmanned aerial vehicle after receiving/passing of the package; and a takeoff portion from which the unmanned aerial vehicle with the center of gravity position adjusted takes off.

A package receiving or passing method of this disclosure includes: a package receiving or passing step of receiving a package mounted to a landed unmanned aerial vehicle or passing a package to the unmanned aerial vehicle; a center of gravity adjustment step of adjusting, before takeoff, a center of gravity position of the unmanned aerial vehicle after the package receiving or passing step; and a takeoff step of causing the unmanned aerial vehicle with the center of gravity position adjusted, to take off.

With the package receiving or passing apparatus or method of this disclosure, the center of gravity position of the unmanned aerial vehicle after a package is received from the unmanned aerial vehicle or a package is passed to the unmanned aerial vehicle is adjusted, whereby flight of the unmanned aerial vehicle after package receiving or package passing can be stabilized.

### BRIEF DESCRIPTION OF THE DRAWINGS

FIG. 1 is a top view of an unmanned aerial vehicle in first to third embodiments as seen from above;

FIG. 2 is a sectional view of the unmanned aerial vehicle along line II-II in FIG. 1;

FIG. 3 is a sectional view of the unmanned aerial vehicle along line in FIG. 1;

FIG. 4 is an exploded perspective view of the unmanned aerial vehicle in the first to third embodiments;

FIG. 5 is a sectional view of the unmanned aerial vehicle along line V-V in FIG. 1;

FIG. 6 is a bottom view of a package-chamber cover as seen from below;

FIG. 7 is a bottom view of a body of the unmanned aerial vehicle as seen from below;

FIG. 8 is a flowchart showing a procedure for mounting a package and a battery to the unmanned aerial vehicle;

FIG. 9 is a perspective view of an aerial-vehicle port in the first to third embodiments;

FIG. 10 is a top view of the aerial-vehicle port in the first to third embodiments as seen from above;

FIG. 11 is a sectional view of the aerial-vehicle port along line XI-XI in FIG. 10;

FIG. 12 is a sectional view of the aerial-vehicle port along line XII-XII in FIG. 10;

FIG. 13 is a sectional view of the aerial-vehicle port along line XIII-XIII in FIG. 10;

FIG. 14 shows a scene in which a package-receiving person receives a package in a locker room of the aerial-vehicle port;

FIG. 15 is a block diagram showing an electric configuration of the aerial-vehicle port;

FIG. 16 is a flowchart showing a procedure for receiving a package from the unmanned aerial vehicle or passing a package to the unmanned aerial vehicle, at the aerial-vehicle port;

FIG. 17 is a sectional view of the aerial-vehicle port at the same position as line XII-XII in FIG. 10 and shows a state in which the aerial vehicle is landed;

FIG. 18 is a sectional view of the aerial-vehicle port at the same position as line XII-XII in FIG. 10 and shows a state in which the landed aerial vehicle is moved to an indoor area;

FIG. 19 is a sectional view of the aerial-vehicle port at the same position as line XII-XII in FIG. 10 and shows a state in which an elevating/lowering portion on which packages taken down from the aerial vehicle are placed is lowered;

FIG. 20 is a sectional view of the aerial-vehicle port at the same position as line XIII-XIII in FIG. 10 and shows a state in which the elevating/lowering portion on which the packages taken down from the aerial vehicle are placed is lowered;

FIG. 21 is a flowchart showing the details of step S17 in FIG. 16 in the first embodiment;

FIG. 22 shows an adjustment example of a battery-mounting position in a package chamber;

FIG. 23 is a flowchart showing the details of step S17 in FIG. 16 in the second embodiment;

FIG. 24 is a sectional view of the unmanned aerial vehicle in a third embodiment;

FIG. 25 is a perspective view of a package-chamber cover, a battery tray, a battery, and parts (body-side connector, attachment portion) of a body cover in the third embodiment;

FIG. 26 is a flowchart showing the details of step S17 in FIG. 16 in the third embodiment;

FIG. 27 shows a first modification of a package-chamber cover and is a perspective view of the package-chamber cover having an opening with a lower end cut out, at a side-surface portion; and

FIG. 28 shows a second modification of a package-chamber cover and is a perspective view of the package-chamber cover having an opening with a lower end closed, at a side-surface portion.

### DETAILED DESCRIPTION

### First Embodiment

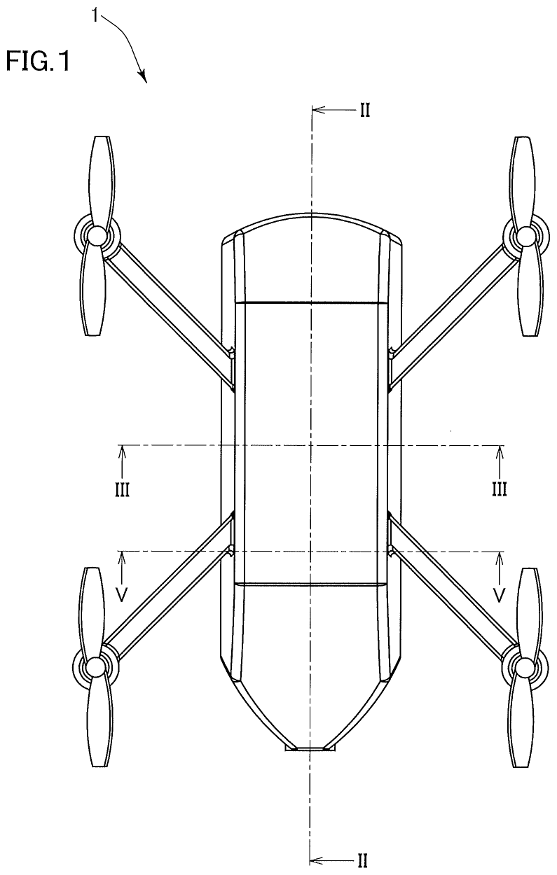

Hereinafter, a first embodiment of this disclosure will be described with reference to the drawings. FIGS. 1 to 4 show an unmanned aerial vehicle 1 (drone) for package transportation in the first embodiment. The unmanned aerial vehicle 1 (hereinafter, may be simply referred to as aerial vehicle) shown in FIGS. 1 to 4 includes a package-chamber tray 2, a package-chamber cover 3, a battery 4, and a body 5.

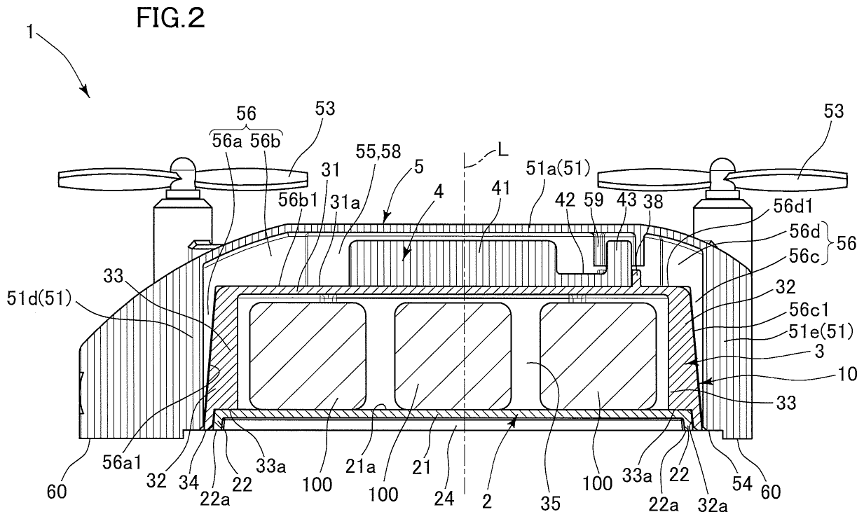

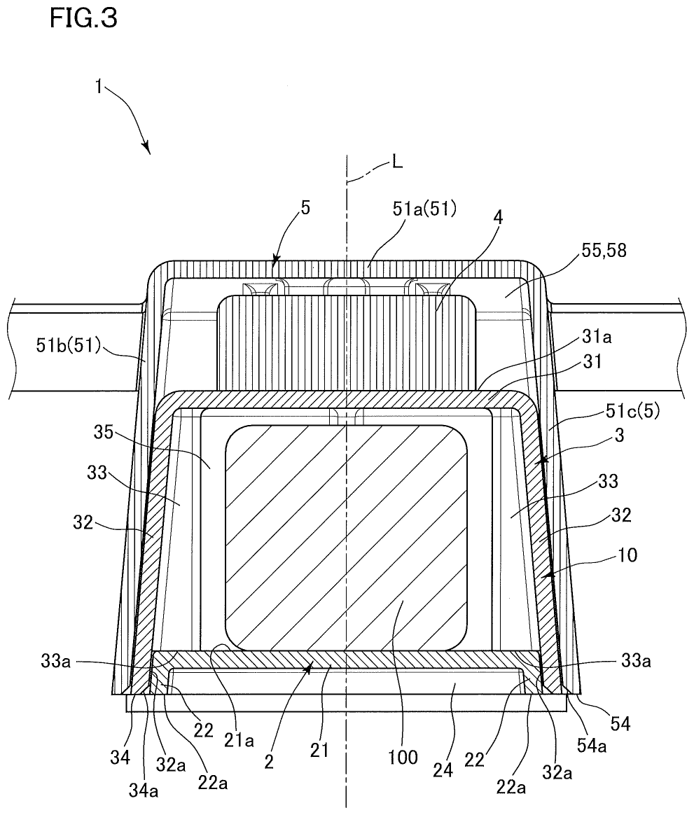

The package-chamber tray 2 is a placement portion on which a package 100 (see FIGS. 2 to 4) is to be placed. The package-chamber tray 2 includes a tray body 21 forming a placement surface 21a (see FIGS. 2 and 3) for the package 100, and an outer-periphery portion 22 located around an outer periphery of the tray body 21. The tray body 21 is formed in a flat-plate shape, for example. An upper surface 21a of the tray body 21 is set as a placement surface for the package 100. The placement surface 21a is formed as a horizontal surface. In this embodiment, a plan-view shape of the placement surface 21a is a rectangle of which a length in the front-rear direction (advancement direction) (direction perpendicular to drawing sheet in FIG. 3) of the aerial vehicle 1 is greater than a length in the left-right direction (left-right direction on drawing sheet in FIG. 3). The placement surface 21a may be formed in a shape other than a rectangle. The placement surface 21a has a size that allows a plurality of (for example, three) packages 100 to be placed thereon.

The outer-periphery portion 22 is provided over the entire outer periphery of the tray body 21 so as to protrude downward from the tray body 21. In a case where the plan-view shape of the tray body 21 is a rectangle, the outer-periphery portion 22 is provided at each of four sides forming the rectangle. The outer-periphery portion 22 is formed in a slightly sloped shape so as to be gradually displaced outward (a direction away from a package-chamber centerline L shown in FIGS. 2 and 3) as approaching the lower side from the tray body 21. The package-chamber centerline L is a line passing the center of the placement surface 21a and perpendicular to the placement surface 21a. Since the outer-periphery portion 22 is formed in a slightly sloped shape, the package-chamber tray 2 can be easily inserted (attached) into a space 35 in the package-chamber cover 3. By the tray body 21 and the outer-periphery portion 22, a space 24 (see FIGS. 2 and 3) opened on the lower side and closed on the sides (upper side and lateral sides) other than the lower side is formed under the tray body 21.

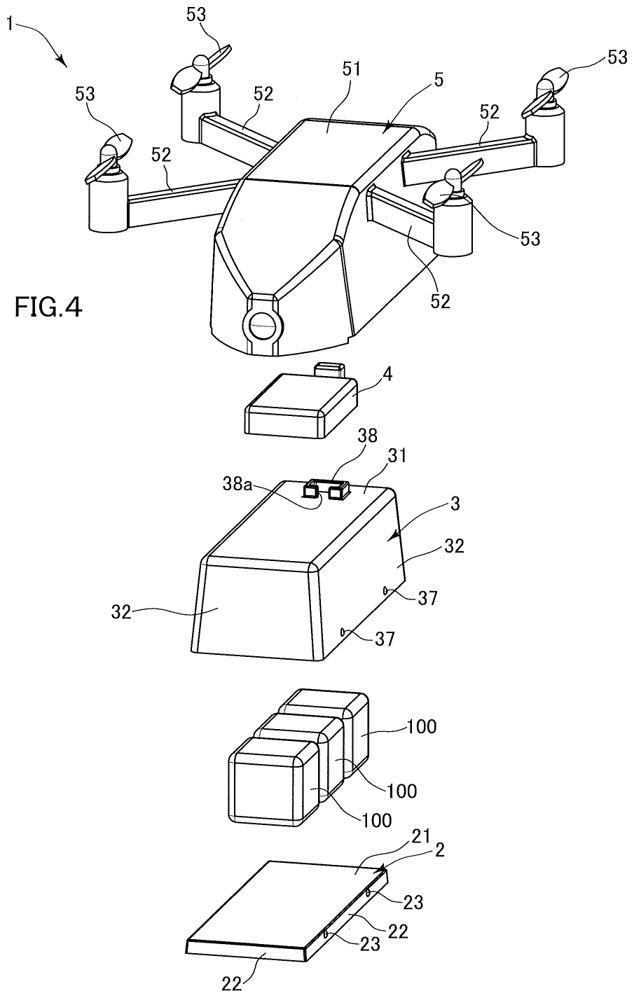

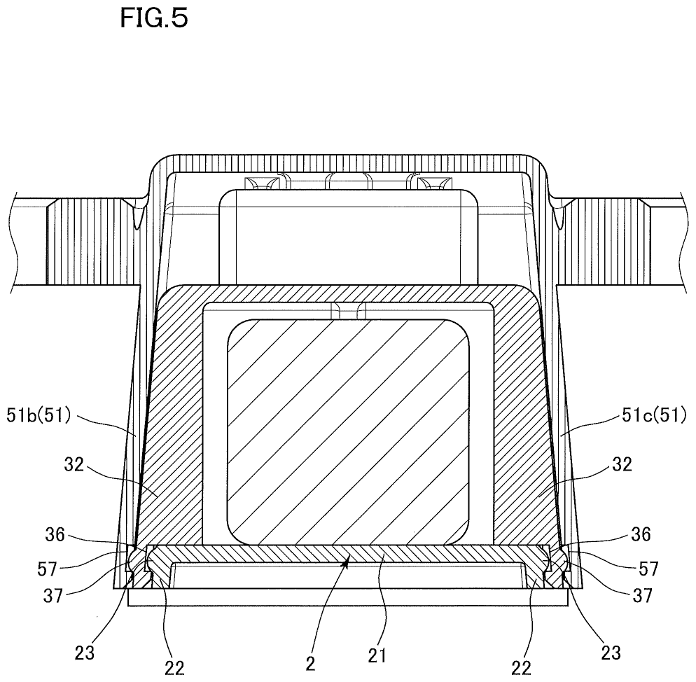

The package-chamber tray 2 is provided so as to be attachable and detachable to and from the package-chamber cover 3. Specifically, the package-chamber tray 2 is attached to the package-chamber cover 3 from below the package-chamber cover 3, and is provided so as to be detachable downward from the package-chamber cover 3. More specifically, as shown in FIGS. 4 and 5, the package-chamber tray 2 includes attachment portions 23 to be attached to the package-chamber cover 3. The attachment portions 23 are provided at the outer surface of the outer-periphery portion 22, for example. The attachment portions 23 are provided at a plurality of positions along the peripheral direction around the package-chamber tray 2. In this embodiment, two attachment portions 23 are provided on each of two sides extending in the front-rear direction (advancement direction) of the aerial vehicle 1, among the outer-periphery portions 22 forming the four sides of the rectangle (see FIG. 4). However, the attachment portions 23 may be provided on sides extending in the left-right direction, among the outer-periphery portions 22 forming the four sides of the rectangle. The number of the attachment portions 23 may be any number.

Each attachment portion 23 is formed in a shape to be engaged (i.e., fitted) with an attachment portion 36 (see FIG. 5) on the package-chamber cover 3 side. Specifically, the attachment portion 23 is formed in a protrusion shape (projection shape), for example, and the attachment portion 36 on the package-chamber cover 3 side is formed in a groove shape (recess shape). In a state in which the package-chamber tray 2 is attached to the package-chamber cover 3, the protrusion-shaped attachment portion 23 is fitted to the groove-shaped attachment portion 36. The attachment portions 23, 36 are configured to keep the engagement state between the attachment portions 23, 36 unless a predetermined release operation is performed. In addition, the attachment portions 23, 36 are configured such that the engagement state between the attachment portions 23, 36 is released when the predetermined release operation is performed. For example, the engagement force (engagement amount between protrusion and groove) between the attachment portions 23, 36 is set such that engagement between the attachment portions 23, 36 is released when an operation of pulling the package-chamber cover 3 upward is performed with the package-chamber tray 2 held so as not to move upward or when an operation of pulling the package-chamber tray 2 downward is performed with the package-chamber cover 3 held so as not to move downward. Alternatively, the protrusion of the attachment portion 23 may be configured to be movable so as to retract mechanically or electrically. In this case, when the protrusion of the attachment portion 23 is retracted, engagement between the attachment portions 23, 36 is released.

The attachment portion 23 on the package-chamber tray 2 side may be formed in a groove shape and the attachment portion 36 on the package-chamber cover 3 side may be formed in a protrusion shape. The engagement configuration between the attachment portions 23, 36 may be other than fitting between a projection and a recess, and for example, may be a bolt-latch type. In a case where the attachment portions 23, 36 are configured as a bolt-latch type, the attachment portions 23, 36 are formed by including a through-hole formed on the package-chamber tray 2 side, a through-hole formed on the package-chamber cover 3 side, and a bolt member to be inserted into the two through-holes aligned with each other. When the bolt member is inserted into the two through-holes, the package-chamber tray 2 and the package-chamber cover 3 come into an attached state, and when insertion of the bolt member into the two through-holes is released, the package-chamber tray 2 and the package-chamber cover 3 are separated.

As shown in FIGS. 2 and 3, the package-chamber tray 2 is attached to the package-chamber cover 3 so as to close a downward opening 34 of the package-chamber space 35 in the package-chamber cover 3. In a state in which the package-chamber tray 2 is attached to the package-chamber cover 3, the tray body 21 is located on the inner side of the package-chamber space 35 relative to the downward opening 34 of the package-chamber cover 3. In addition, the entire periphery of an outer surface of the outer-periphery portion 22 contacts with (is positioned by) an inner surface 32a of a side-surface portion 32 of the package-chamber cover 3, whereby movement of the package-chamber tray 2 in the horizontal direction relative to the package-chamber cover 3 is restricted. In addition, parts of an outer-periphery portion of the upper surface of the tray body 21 contact with (are positioned by) lower ends 33a of inner protruding portions 33 provided to the package-chamber cover 3, whereby upward movement of the package-chamber tray 2 relative to the package-chamber cover 3 is restricted. Meanwhile, downward movement of the package-chamber tray 2 relative to the package-chamber cover 3 is restricted by the attachment portions 23, 36. In the state in which the package-chamber tray 2 is attached to the package-chamber cover 3, a lower end 22a of the outer-periphery portion 22 is located at substantially the same up-down-direction position as a lower end 34 (downward opening) of the package-chamber cover 3.

The package-chamber cover 3 is attachable and detachable to and from the package-chamber tray 2. Specifically, the package-chamber cover 3 is attached to the package-chamber tray 2 from above the package-chamber tray 2 so as to cover the package 100 placed on the package-chamber tray 2. The package-chamber cover 3 is provided so as to be detachable (separable) upward of the package-chamber tray 2.

Specifically, the package-chamber cover 3 is formed in a substantially rectangular parallelepiped shape, for example, but may be formed in a shape other than a substantially rectangular parallelepiped shape. The package-chamber cover 3 includes an upper-surface portion 31 and the side-surface portion 32. The upper-surface portion 31 and the side-surface portion 32 form the package-chamber space 35 having an opening 34 on the lower side and closed on all the sides (lateral sides and upper side) other than the lower side. Thus, the package-chamber cover 3 is formed in a box shape opened on the lower side, in a state in which the package-chamber tray 2 is separated. When the package-chamber tray 2 is attached to the package-chamber cover 3, the opening 34 of the package-chamber space 35 is closed by the package-chamber tray 2, so that all the sides (including lower side) of the package-chamber space 35 are closed. In the closed package-chamber space 35, the package 100 placed on the package-chamber tray 2 is housed. The package-chamber space 35 has a size that allows a plurality of packages 100 to be housed therein. In FIG. 2, three packages 100 are housed in the package-chamber space 35 so as to be arranged in the front-rear direction of the package-chamber space 35, as an example. However, the number of the packages 100 may be any number, and the arrangement direction of the packages 100 may be any of horizontal directions (e.g., left-right direction).

The upper-surface portion 31 is formed in, for example, a rectangular flat-plate shape of which a length in the front-rear direction (advancement direction) of the aerial vehicle 1 is greater than a length in the left-right direction, in a plan view. However, without limitation thereto, the upper-surface portion 31 may be formed in any shape such as a square (a rectangle having equal lengths in the left-right direction and the front-rear direction), a rectangle of which a length in the left-right direction is greater than a length in the front-rear direction, or an ellipse. An outer surface 31a (upper surface) of the upper-surface portion 31 is formed as a horizontal surface. The outer surface 31a is formed as a battery-placement surface (i.e., battery-mounting portion) on which the battery 4 is placed. The outer surface 31a is formed as a battery-mounting portion that allows the mounting position of the battery 4 to be adjusted at the time of placing the battery 4 on the outer surface 31a.

On the outer surface 31a, a connector holder 38 for holding a connector 43 of the battery 4 so that the connector 43 does not move is provided integrally with the outer surface 31a (see FIGS. 2 and 4). The connector holder 38 is formed in a shape protruding upward from the outer surface 31a and surrounding the periphery of the connector 43. The connector holder 38 has a linking portion 38a through which the inner side (housing space for connector 43) and the outer side of the connector holder 38 (see FIG. 4) communicate with each other. A wire 42 of the battery 4 passes through the linking portion 38a. The connector holder 38 is provided at a position opposed to a connector 59 provided to the body 5 in a state in which the package-chamber cover 3 is attached to the body 5 (see FIG. 2). That is, the connector holder 38 is provided at such a position that the connector 43 of the battery 4 and the connector 59 of the body 5 are connected when a package chamber 10 (package-chamber tray 2 and package-chamber cover 3) with the battery 4 mounted thereto is attached to the body 5.

The side-surface portion 32 of the package-chamber cover 3 is formed in a plate shape extending downward from the entire outer periphery of the upper-surface portion 31. The side-surface portion 32 includes a front-surface portion facing in the advancement direction of the aerial vehicle 1, a rear-surface portion facing in the rearward direction opposite to the advancement direction, a left-surface portion facing in the leftward direction with respect to the advancement direction, and a right-surface portion facing in the rightward direction with respect to the advancement direction. The side-surface portion 32 is formed in a slightly sloped shape so as to be gradually displaced outward (a direction away from the package-chamber centerline L shown in FIGS. 2 and 3) as approaching the lower side from the upper-surface portion 31. Since the side-surface portion 32 is formed in a slightly sloped shape as described above, the package-chamber cover 3 can be easily inserted (attached) into a space 55 in a body cover 51 described later. A slope angle of the side-surface portion 32 with respect to the package-chamber centerline L is the same as a slope angle of the outer-periphery portion 22 of the package-chamber tray 2 with respect to the package-chamber centerline L. Thus, when the package-chamber tray 2 is attached to the package-chamber cover 3, the outer surface of the outer-periphery portion 22 and the inner surface of the side-surface portion 32 can closely contact with each other. However, the slope angle of the side-surface portion 32 and the slope angle of the outer-periphery portion 22 may be different from each other.

The lower end 34 of the side-surface portion 32 forms an opening having the same shape as the plan-view shape of the package-chamber tray 2, as seen in a plan view. The inner-edge side of the lower end 34 is formed in such a taper shape 34a that the width of the opening 34 is gradually reduced as approaching the upper side (see FIG. 3). The taper shape 34a is formed over the entire periphery of the opening 34. Owing to the taper shape 34a, the package-chamber tray 2 can be easily put inside the opening 34 at the time of attaching the package-chamber tray 2 to the package-chamber cover 3.

At the inner surface 32a of the side-surface portion 32, the inner protruding portions 33 protruding inward (package-chamber centerline L side) are formed (see FIGS. 2, 3, and 6). As shown in FIG. 6, a plurality of the inner protruding portions 33 are arranged with an interval therebetween along the periphery direction of the side-surface portion 32. Specifically, one inner protruding portion 33 is provided to each of the front-surface portion and the rear-surface portion among the side-surface portions 32 on the front, rear, left, and right sides, and two inner protruding portions 33 are provided to each of the left-surface portion and the right-surface portion. The inner protruding portions 33 provided to the front-surface portion and the rear-surface portion are located at the centers of the widths in the left-right direction of the front-surface portion and the rear-surface portion.

As shown in FIGS. 2 and 3, each inner protruding portion 33 has a lower end 33a at a position distant upward from the lower end 34 (opening) of the side-surface portion 32 and extends from the lower end 33a to the position of the upper-surface portion 31. That is, an upper end of the inner protruding portion 33 is connected to the upper-surface portion 31. The lower end 33a of the inner protruding portion 33 is formed to represent a horizontal line as seen in the directions of FIGS. 2 and 3. As described above, the lower end 33a and the upper surface 21a of the package-chamber tray 2 contact with each other. In FIGS. 2 and 3, the package-chamber tray 2 is positioned in the up-down direction by ribs (inner protruding portions 33) protruding from the inner surface of the side-surface portion 32 of the package-chamber cover 3, as an example. However, the positioning may be made by means other than ribs. For example, the side-surface portion 32 of the package-chamber cover 3 may be formed to have such a protruding sectional shape that the remaining part other than the lower part of the side-surface portion 32 where the package-chamber tray 2 is located protrudes inward, similarly to FIG. 2, as seen in a cross-section along any of front-rear-direction lines parallel to a front-rear-direction centerline (line II-II) in FIG. 1 or a cross-section along any of left-right-direction lines parallel to a left-right-direction centerline (line III-III) in FIG. 1.

As described above, the package-chamber cover 3 is attachable and detachable to and from the package-chamber tray 2. Specifically, the package-chamber cover 3 has, at the inner surface 32a of the side-surface portion 32, the attachment portions 36 having shapes engageable with the attachment portions 23 on the package-chamber tray 2 side (see FIG. 5). As described above, each attachment portion 36 is formed in a groove shape (recess shape) to be fitted to the protrusion-shaped attachment portion 23, for example. The attachment portion 36 is provided at a position lower than the lower end 33a of the inner protruding portion 33, on the inner surface 32a. The attachment portions 36 are provided at a plurality of positions along the periphery direction of the package-chamber cover 3 so as to correspond to the positions of the attachment portions 23 on the package-chamber tray 2 side.

The package-chamber cover 3 is attachable and detachable to and from the body 5. Specifically, as shown in FIGS. 4 and 5, the package-chamber cover 3 includes attachment portions 37 to be attached to the body 5. The attachment portions 37 are provided at an outer surface of the side-surface portion 32, for example. The attachment portions 37 are provided at a plurality of positions along the periphery direction of the package-chamber cover 3. In this embodiment, two attachment portions 37 are provided to each of the left-surface portion and the right-surface portion, among the side-surface portions 32 on the front, rear, left, and right sides (see FIG. 4). However, the attachment portions 37 may be provided to the front-surface portion and the rear-surface portion, among the side-surface portions 32 on the front, rear, left, and right sides. The number of the attachment portions 37 may be any number.

Each attachment portion 37 is formed in a shape to be engaged (i.e., fitted) with an attachment portion 57 (see FIG. 5) on the body 5 side. Specifically, the attachment portion 37 is formed in a protrusion shape (projection shape), for example, and the attachment portion 57 on the body 5 side is formed in a groove shape (recess shape). In a state in which the package-chamber cover 3 is attached to the body 5, the protrusion- shaped attachment portion 37 is fitted to the groove-shaped attachment portion 57. The attachment portions 37, 57 are configured to keep the engagement state between the attachment portions 37, 57 unless a predetermined release operation is performed. In addition, the attachment portions 37, 57 are configured such that the engagement state between the attachment portions 37, 57 is released when the predetermined release operation is performed. For example, the engagement force (engagement amount between protrusion and groove) between the attachment portions 37, 57 is set such that engagement between the attachment portions 37, 57 is released when an operation of pulling the body 5 upward is performed with the package-chamber cover 3 held so as not to move upward or when an operation of pulling the package-chamber cover 3 downward is performed with the body 5 held so as not to move downward. Alternatively, the protrusion of the attachment portion 37 may be configured to be movable so as to retract mechanically or electrically. In this case, when the protrusion of the attachment portion 37 is retracted, engagement between the attachment portions 37, 57 is released.

The attachment portion 37 on the package-chamber cover 3 side may be formed in a groove shape and the attachment portion 57 on the body 5 may be formed in a protrusion shape. The engagement configuration between the attachment portions 37, 57 may be other than fitting between a projection and a recess, and for example, may be a bolt-latch type. In a case where the attachment portions 37, 57 are configured as a bolt-latch type, the attachment portions 37, 57 are formed by including a through-hole formed on the package-chamber cover 3 side, a through-hole formed on the body 5 side, and a bolt member to be inserted into the two through-holes aligned with each other. When the bolt member is inserted into the two through-holes, the package-chamber cover 3 and the body 5 come into an attached state, and when insertion of the bolt member into the two through-holes is released, the package-chamber cover 3 and the body 5 are separated.

By the package-chamber tray 2 and the package-chamber cover 3 being integrated, the package chamber 10 is formed. The package chamber 10 is attachable and detachable to and from the body 5 (specifically, body cover 51 described later). Specifically, the package chamber 10 is attached to the body 5 from below the body 5, and is provided so as to be detachable downward from the body 5. As shown in FIGS. 2 and 3, the package chamber 10 is attached to the body 5 so as to be housed in the body space 55 formed in the body 5. In this embodiment, in a state in which the package chamber 10 is attached to the body 5, the entire package chamber 10 is housed in the body space 55. However, a part on the lower-end side of the package chamber 10 may be exposed to the outside of the body space 55. In a state in which the package chamber 10 is attached to the body 5, a lower end (lower end 34 of package-chamber cover 3 or lower end 22a of package-chamber tray 2) of the package chamber 10 may be located at the same up-down-direction position as a downward opening 54 of the body space 55, may be located on the inner side of the body space 55 relative to the downward opening 54, or may be located at a position exposed to the outside from the downward opening 54.

In a state in which the package chamber 10 is attached to the body 5, the downward opening 54 of the body space 55 is closed by the package chamber 10. Further, in the state in which the package chamber 10 is attached to the body 5, the entire outer surfaces of the side-surface portions 32 on the left and right sides of the package-chamber cover 3 contact with (are positioned by) wall surfaces of the body space 55, whereby leftward/rightward movement of the package chamber 10 relative to the body 5 is restricted (see FIG. 3). In addition, in the state in which the package chamber 10 is attached to the body 5, parts of the outer surfaces of the side-surface portions 32 on the front and rear sides of the package-chamber cover 3 contact with (are positioned by) inner protruding portions 56 provided in the body space 55, whereby frontward/rearward movement of the package chamber 10 relative to the body 5 is restricted (see FIG. 2). In addition, in the state in which the package chamber 10 is attached to the body 5, parts of the outer surface 31a of the upper-surface portion 31 of the package-chamber cover 3 contact with (are positioned by) the inner protruding portions 56, whereby upward movement of the package chamber 10 relative to the body 5 is restricted (see FIG. 2). Downward movement of the package chamber 10 relative to the body 5 is restricted by the attachment portions 37, 57. As described above, in this embodiment, there is no space for adjusting the position of the package chamber 10, in the body space 55.

As described above, the battery 4 is mounted on the upper-surface portion 31 of the package-chamber cover 3. The battery 4 is housed in a battery-housing space 58 formed by the upper surface 31a of the package chamber 10 (package-chamber cover 3) and a wall surface of the body space 55 (see FIGS. 2 and 3). The battery 4 is a battery for driving the aerial vehicle 1, and more specifically, a battery for supplying power to a driving portion for a rotary blade 53 as a lift-generation portion provided to the body 5. The battery 4 is a rechargeable secondary battery. As the battery 4, various secondary batteries are applicable. For example, a nickel hydrogen battery, a lithium polymer battery, a lithium ion battery, or a lithium ferrite battery may be used.

As shown in FIG. 2, the battery 4 includes a battery body 41, the wire 42, and the connector 43. The battery body 41 supplies power to the outside via the wire 42 and the connector 43. The battery body 41 is mounted with spaces (spaces allowing position adjustment) provided in horizontal directions (front-rear direction and left-right direction) in the battery-housing space 58. The battery body 41 is mounted in a state in which upward/downward movement thereof is restricted by the upper-surface portion 31 of the package-chamber cover 3 and the upper surface of the body space 55.

The wire 42 connects the battery body 41 and the connector 43. The length of the wire 42 includes an extra length so as to allow the battery body 41 to be mounted at any position in the horizontal direction in the battery-housing space 58. The connector 43 is held by the aforementioned connector holder 38 so as not to move. The connector 43 is connected to the connector 59 on the body 5 side. The connector 43 and the connector 59 are attachable and detachable to and from each other. In this disclosure, the connector 43 corresponds to a first connector and the connector 59 corresponds to a second connector. The connector holder 38 corresponds to a holding portion.

At the time of attaching the battery 4 onto the package-chamber cover 3 (at the time of mounting the battery 4 to the aerial vehicle 1), the position of the battery body 41 can be adjusted in the horizontal direction in the battery-housing space 58. Meanwhile, it is undesirable that the mounting position of the battery body 41 unintentionally changes during flight of the aerial vehicle 1. Therefore, in order to prevent the battery body 41 from moving on the upper surface 31a of the package-chamber cover 3 during flight, the battery body 41 may be fixed to the upper surface 31a by simple means such as a hook-and-loop fastener.

The rotary blade 53 as a lift-generation portion and a thrust-generation portion is connected to the body 5. That is, the body 5 is configured to be able to fly. As shown in FIG. 4, the body 5 includes the body cover 51, an arm 52 connected to the body cover 51, and the rotary blade 53 (propeller) connected to an end of the arm 52. The arm 52 is provided so as to protrude laterally from the body cover 51, for example. A plurality of the arms 52 and a plurality of rotary blades 53 (in the example in FIG. 4, four of each) may be provided.

Further, the body 5 includes a driving portion (motor) for driving the rotary blades 53, a communication portion, a sensor portion, a recording portion, and a control portion (not shown). The communication portion is a part for communicating with an external management device (not shown) during flight, and for example, transmits a detected value (e.g., present-location information) of the sensor portion to the management device or receives a flight-control signal from the management device. The sensor portion may include various sensors, e.g., a camera, GPS sensor, an acceleration sensor, a gyro sensor, an infrared sensor, a voice sensor, a brightness sensor, a wind-direction/wind-speed sensor, a geomagnetic sensor, an altitude sensor, a displacement sensor, a temperature sensor, a heat sensor, or a pressure sensor. The recording portion records therein various data needed for transportation of the package 100. The recording portion may record therein transportation-destination information of the package 100 so that autonomous flight can be performed when communication with the external management device is impossible. The control portion controls driving of the rotary blades 53 on the basis of the detected value of the sensor portion, the flight-control signal received by the communication portion, and the like.

The body cover 51 is formed in a box shape (i.e., substantially rectangular parallelepiped shape) having the opening 54 on the lower side. Specifically, the body cover 51 is formed in a shape having an upper-surface portion 51a, left and right side-surface portions 51b, 51c, a front-surface portion 51d, and a rear-surface portion 51e. Inside these surface portions 51a to 51e, the body space 55 having the opening 54 on the lower side and closed on the sides (left, right, front, rear, and upper sides) other than the lower side is formed. The opening 54 is formed in the same shape as the plan-view shape of the package chamber 10, as seen in a plan view. The body space 55 is a space for housing the package chamber 10 and the battery 4 mounted therein. Of the body space 55, the space 58 surrounded by the upper surface 31a of the package chamber 10 and the upper-surface portion 51a of the body cover 51 is set as the aforementioned battery-housing space.

The inner-edge side of the part forming the opening 54 of the body cover 51 is formed in such a taper shape 54a that the width of the opening 54 is gradually reduced as approaching the upper side (see FIG. 3). The taper shape 54a is formed over the entire periphery of the opening 54. Owing to the taper shape 54a, the package chamber 10 can be easily put into the body space 55 at the time of attaching the package chamber 10 to the body cover 51.

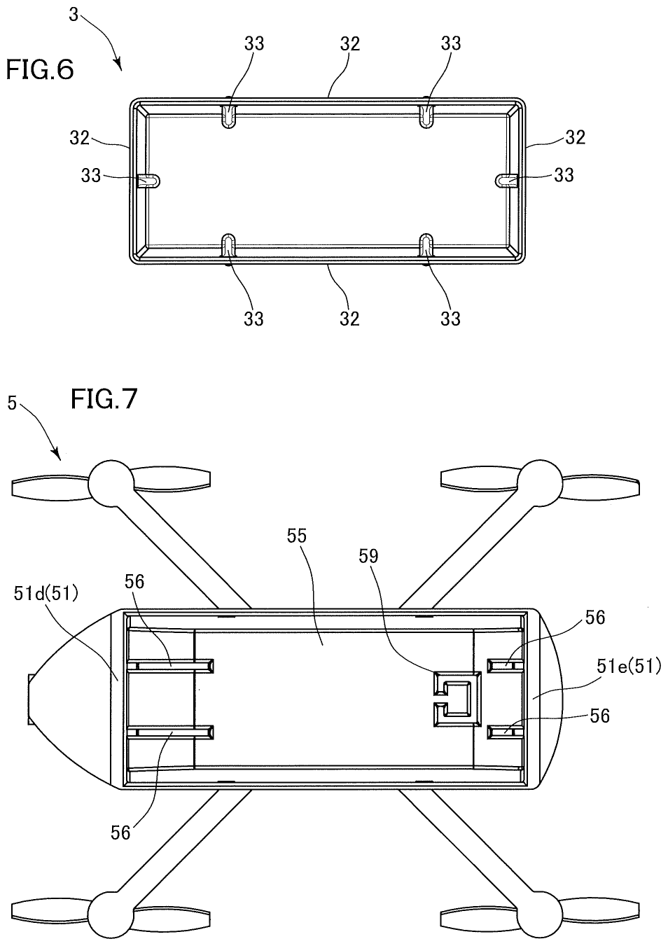

The inner protruding portions 56 protruding toward the inside of the body space 55 are formed at wall surfaces of the body space 55 (see FIGS. 2 and 7). The inner protruding portions 56 are formed at four locations in total, i.e., two locations on the front side and two locations on the rear side in the front-rear direction (see FIG. 7). Specifically, as shown in FIG. 2, each inner protruding portion 56 located at the front of the package-chamber cover 3 includes a first protruding portion 56a protruding rearward from an inner surface (a surface facing the body space 55) of the front-surface portion 51d, and a second protruding portion 56b protruding downward from an inner surface (a surface facing the body space 55) of the upper-surface portion 51a. The first protruding portion 56a and the second protruding portion 56b are continuously formed. The first protruding portion 56a is formed continuously from the position of the opening 54 of the body space 55 to the position of the upper-surface portion 51a (second protruding portion 56b). The first protruding portion 56a is formed in such a shape that the rearward protruding amount thereof gradually increases as approaching the upper side. That is, a rearward protruding end 56a1 of the first protruding portion 56a is formed in a sloped shape so as to be gradually displaced rearward as approaching the upper side. A slope angle of the protruding end 56a1 with respect to the package-chamber centerline L (vertical direction) is the same as the slope angle of the front-surface portion of the package-chamber cover 3 with respect to the package-chamber centerline L. That is, in a state in which the package-chamber cover 3 is attached to the body cover 51, the entire protruding end 56a1 contacts with the front-surface portion of the package-chamber cover 3.

The second protruding portion 56b is formed to protrude downward from a front-side part of the upper-surface portion 51a. A downward protruding end 56b1 of the second protruding portion 56b is formed in parallel to a horizontal plane, i.e., formed to represent a horizontal line as seen in the direction of FIG. 2. That is, in a state in which the package-chamber cover 3 is attached to the body cover 51, the entire protruding end 56b1 contacts with the upper surface 31a of the package-chamber cover 3.

As shown in FIG. 2, the inner protruding portion 56 located at the rear of the package-chamber cover 3 includes a third protruding portion 56c protruding frontward from an inner surface (a surface facing the body space 55) of the rear-surface portion 51e and a fourth protruding portion 56d protruding downward from an inner surface (a surface facing the body space 55) of the upper-surface portion 51a. The third protruding portion 56c and the fourth protruding portion 56d are continuously formed. The third protruding portion 56c is formed in such a shape that the frontward protruding amount thereof gradually increases as approaching the upper side. That is, a frontward protruding end 56c1 of the third protruding portion 56c is formed in a sloped shape so as to be gradually displaced frontward as approaching the upper side. A slope angle of the protruding end 56c1 with respect to the package-chamber centerline L is the same as the slope angle of the rear-surface portion of the package-chamber cover 3 with respect to the package-chamber centerline L. That is, in a state in which the package-chamber cover 3 is attached to the body cover 51, the entire protruding end 56c1 contacts with the rear-surface portion of the package-chamber cover 3.

The fourth protruding portion 56d is formed to protrude downward from a rear-side part of the upper-surface portion 51a. A downward protruding end 56d1 of the fourth protruding portion 56d is formed in parallel to a horizontal plane, i.e., formed to represent a horizontal line as seen in the direction of FIG. 2. That is, in a state in which the package-chamber cover 3 is attached to the body cover 51, the entire protruding end 56d1 contacts with the upper surface 31a of the package-chamber cover 3.

Thus, frontward/rearward movement and upward movement of the package chamber 10 relative to the body cover 51 are restricted by the four inner protruding portions 56. The inner protruding portions 56 serve as positioning portions that determine the position of the package chamber 10 in the body space 55, i.e., serve as movement-restricting portions that restrict movement of the package chamber 10 relative to the body cover 51. Leftward/rightward movement of the package chamber 10 is restricted by the left and right side-surface portions 51b, 51c of the body cover 51 (see FIG. 3). As described above, downward movement of the package chamber 10 is restricted by the attachment portions 37, 57.

Lower surfaces 60 (see FIG. 2) of the body cover 51 are located at the front and the rear of the opening 54, and are provided so as to be stepped downward from the opening 54. The lower surfaces 60 are formed as horizontal surfaces. The lower surfaces 60 serve as contact surfaces contacting with the ground in a state in which the aerial vehicle 1 is landed. The lower end of the package chamber 10 (lower end 22a of package-chamber cover 2 and lower end 34 of package-chamber cover 3) is located at a position higher than the lower surfaces 60. That is, in a state in which the package chamber 10 is attached to the body cover 51, the lower ends 22a, 34 of the package chamber 10 are slightly spaced from the ground.

The body cover 51 is attachable and detachable to and from the package chamber 10 (package-chamber cover 3). Specifically, the body cover 51 is attached to the package chamber 10 from above the package chamber 10, and is provided so as to be detachable upward from the package chamber 10. More specifically, the body cover 51 has, at the inner surfaces of the left and right side-surface portions 51b, 51c, the attachment portions 57 having shapes engageable with the attachment portions 37 on the package-chamber cover 3 side (see FIG. 5). As described above, each attachment portion 57 is formed in a groove shape (recess shape) to be fitted to the protrusion-shaped attachment portion 37, for example. The attachment portions 57 are provided at a plurality of positions along the periphery direction of the body cover 51 so as to correspond to the positions of the attachment portions 37 on the package-chamber cover 3 side.

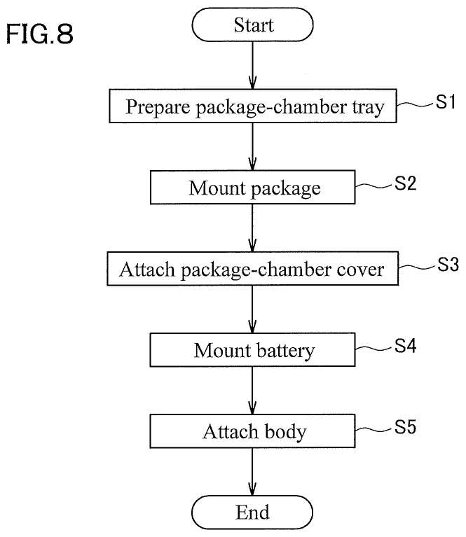

Next, a procedure for mounting the package 100 and the battery 4 to the aerial vehicle 1 (body 5) will be described. FIG. 8 shows a flowchart of the procedure.

First, an empty package-chamber tray 2 is prepared (S1). Next, one or a plurality of packages 100 are placed on the prepared package-chamber tray 2 (S2). In a case of placing a plurality of packages 100, for example, a plurality of packages 100 having the same transportation destination may be placed or a plurality of packages 100 having different transportation destinations may be placed. In a case of placing a plurality of packages 100, the plurality of packages 100 may be arranged in the in-plane direction of the package-chamber tray 2 (horizontal direction) (e.g., front-rear direction of package-chamber tray 2). In a case of placing a plurality of packages 100, the mounting position of each package 100 on the package-chamber tray 2 may be adjusted in accordance with the weight of each package 100.

Next, the package-chamber cover 3 is attached, from above, to the package-chamber tray 2 with the package 100 placed thereon in step S2, so that the package-chamber tray 2 and the package-chamber cover 3 are integrated (S3). At this time, the attachment portions 23 of the package-chamber tray 2 and the attachment portions 36 of the package-chamber cover 3 are engaged with each other (see FIG. 5) so that the package-chamber cover 3 does not come off the package-chamber tray 2.

Next, the battery 4 is mounted on the upper surface of the package chamber 10 obtained in step S3 (S4). At this time, the battery 4 having a capacity corresponding to the weight of each package 100 and the flight planned distance of the aerial vehicle 1 may be selected. For example, as the weight of the package 100 increases, the battery 4 having a larger capacity may be selected. For example, as the flight planned distance increases, the battery 4 having a larger capacity may be selected. As the flight planned distance, for example, a total transportation distance from when the aerial vehicle 1 departs a base (place for performing the process in FIG. 8) until the aerial vehicle 1 transports each package 100 to the transportation destination and then returns to the base (place for retrieving the aerial vehicle 1), may be acquired. The battery 4 having such a capacity that allows flight without charging of the battery 4 or replacement with another battery 4 from when the aerial vehicle 1 departs the base until the aerial vehicle 1 returns, may be selected. The battery 4 that has been sufficiently charged (e.g., fully charged (100% charged)) may be selected.

The center of gravity position (weight distribution) of the package 100 placed on the package-chamber tray 2 may be acquired, and the mounting position of the battery body 41 on the upper surface of the package chamber 10 may be adjusted in accordance with the center of gravity position. In this case, since the mounting position of the battery 4 is adjusted in initial setup before the body 5 and the package chamber 10 are integrated, the center of gravity position of the entire aerial vehicle 1 when the package chamber 10 with the package 100 and the battery 4 mounted thereto is integrated with the body 5 can be determined in the initial setup. Thus, center of gravity adjustment for the aerial vehicle 1 can be efficiently performed. The connector 43 is caused to be held by the connector holder 38.

Next, the package chamber 10 at which the package 100 and the battery 4 are placed is attached to the body 5, whereby the package chamber 10 and the body 5 are integrated (S5). At this time, the attachment portions 37 of the package-chamber cover 3 and the attachment portions 57 of the body cover 51 are engaged with each other (see FIG. 5) so that the package-chamber cover 3 (package chamber 10) does not come off the body 5. When the package chamber 10 and the body 5 are attached to each other, the connector 43 of the battery 4 and the connector 59 on the body 5 side are automatically connected. Thus, it becomes possible to supply power to the body 5.

Through the above steps S1 to S5, the aerial vehicle 1 to which the package chamber 10, the packages 100, and the battery 4 are mounted, is completed. Thereafter, the aerial vehicle 1 departs the base and transports each package 100 to a predetermined location. At least one or all of steps Si to S5 may be performed by a robot or a human.

Thereafter, when the aerial vehicle 1 having finished transportation of all the packages 100 has returned to the base, for example, the aerial vehicle 1 is separated into the parts 2, 3, 4, 5, and the parts 2, 3, 4, 5 are retrieved. Separation of the parts 2, 3, 4, 5 of the aerial vehicle 1 may be performed through the following procedure, for example. First, the package chamber 10 is separated from the aerial vehicle 1. Specifically, engagement between the attachment portions 37 of the package-chamber cover 3 and the attachment portions 57 of the body cover 51 of the aerial vehicle 1 is released and the body 5 is pulled upward of the package chamber 10 or the package chamber 10 is pulled downward of the body 5, whereby the body 5 and the package chamber 10 with the battery 4 mounted thereto are separated. Next, the battery 4 placed on the package chamber 10 is retrieved.

Next, the package-chamber cover 3 and the package-chamber tray 2 of the package chamber 10 are separated. Specifically, engagement between the attachment portions 36 of the package-chamber cover 3 and the attachment portions 23 of the package-chamber tray 2 is released and the package-chamber cover 3 is pulled upward of the package-chamber tray 2 or the package-chamber tray 2 is pulled downward of the package-chamber cover 3, whereby the package-chamber cover 3 and the package-chamber tray 2 are separated. Then, the separated package-chamber cover 3 and package-chamber tray 2 are retrieved. A part or the whole of the disassembly of the aerial vehicle 1 may be performed by a robot or a human.

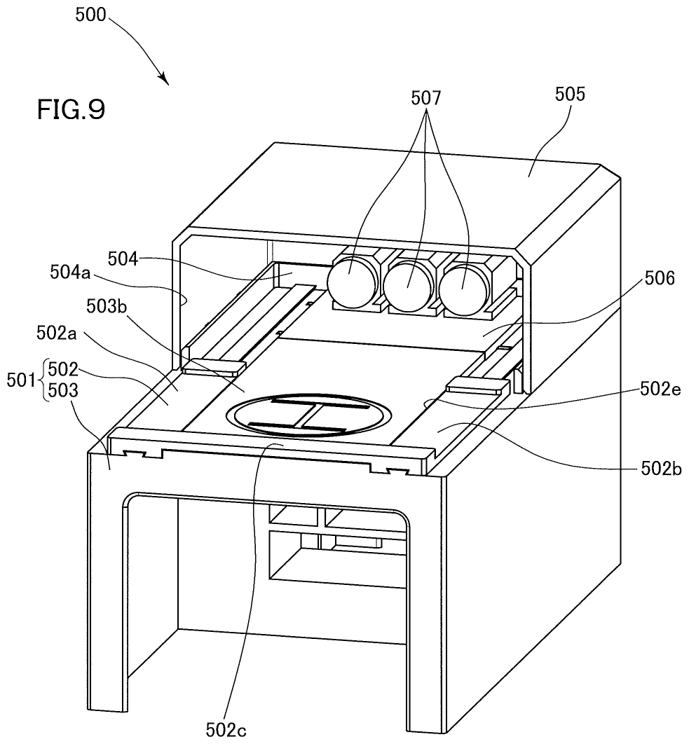

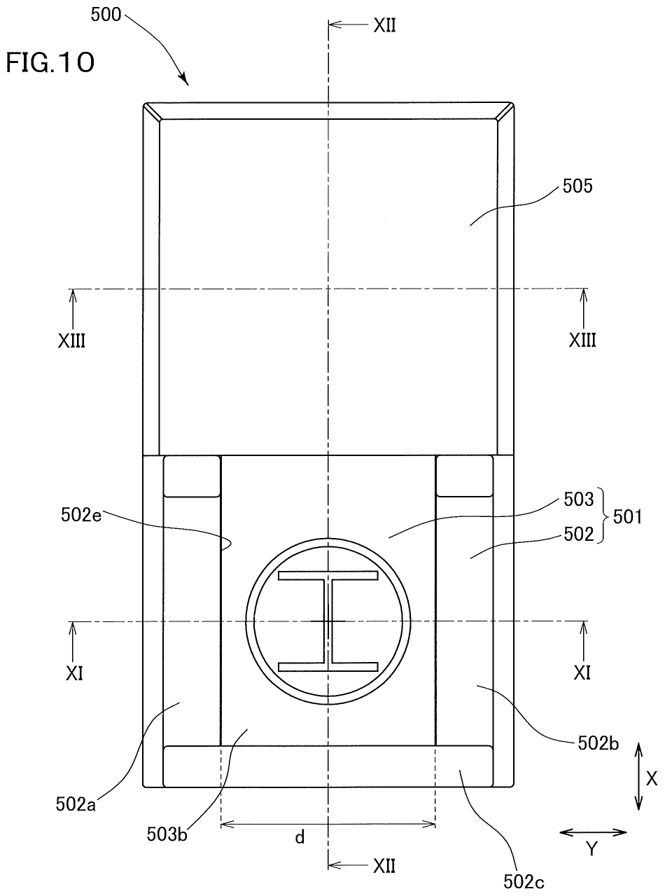

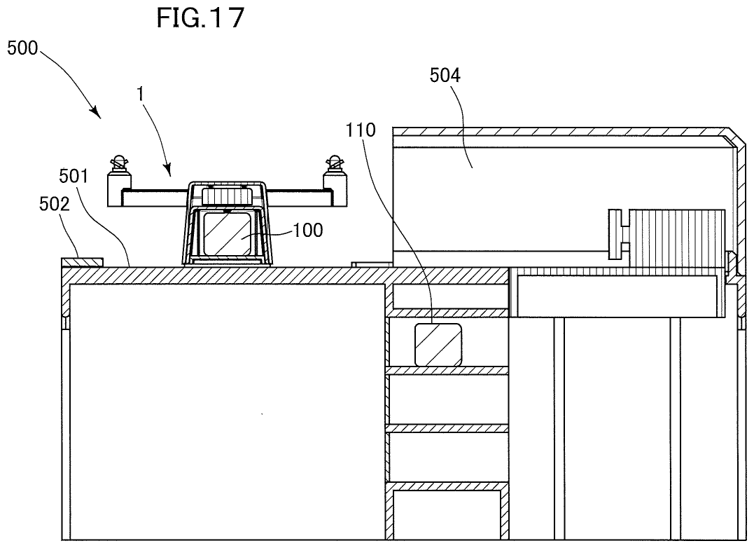

The aerial vehicle 1 with the package 100 mounted thereto flies to an aerial-vehicle port 500 (drone port) as a package receiving or passing apparatus shown in FIGS. 9 to 13, for example. Then, the package 100 is received at the port 500. The port 500 may have a package passing function for passing a package 110 (see FIGS. 17 to 19) to the aerial vehicle 1 from the port 500, in addition to or instead of the function of receiving the package 100 of the aerial vehicle 1. That is, the port 500 is configured as a package receiving or passing apparatus having at least one of the package receiving function and the package passing function. The port 500 may be configured as an apparatus having both of the package receiving function and the package passing function, may be configured as a package receiving apparatus having only the package receiving function, or may be configured as a package passing apparatus having only the package passing function. In a case where the port 500 has the package passing function, the aerial vehicle 1 arriving at the port 500 may not have the package 100 mounted thereto. In the following description, it is assumed that the port 500 has both of the package receiving function and the package passing function. In addition, a package that the port 500 receives from the aerial vehicle 1 is denoted by a reference character “100”, and a package that the port 500 passes to the aerial vehicle 1 is denoted by a reference character “110”.

Hereinafter, the configuration of the port 500 will be described. The aerial vehicle 1 and the port 500 form a package receiving or passing system for receiving the package 100 mounted to the aerial vehicle 1 or passing the package 110 (see FIGS. 17 to 19) stored at the port 500 to the aerial vehicle 1. The port 500 may be provided at any location where the package 100 can be received or the package 110 can be deposited. For example, the port 500 may be provided at a post office, a store such as a convenience store, a housing complex such as an apartment building, or a public facility (such as community center) in a community. The port 500 may be provided at each house.

The port 500 includes a takeoff/landing portion 501, a slider 502, a slider support portion 503, a carry-in/out chamber 504, an elevating/lowering portion 506, a package moving portion 507, a package locker 510, and a locker room 515.

The takeoff/landing portion 501 is a place where the aerial vehicle 1 takes off or lands. The takeoff/landing portion 501 is not provided with a roof, i.e., is provided in an outdoor area. The takeoff/landing portion 501 is formed by including the slider 502 and the slider support portion 503. The takeoff/landing portion 501 corresponds to a landing portion and a takeoff portion in this disclosure.

The slider 502 is provided so as to be horizontally movable between the outdoor area where the takeoff/landing portion 501 is located and the carry-in/out chamber 504 adjacent to the takeoff/landing portion 501. The slider 502 has a pair of support portions 502a, 502b forming support surfaces with which the lower surfaces 60 (see FIG. 2) of the body cover 51 of the aerial vehicle 1 contact in a state in which the aerial vehicle 1 is landed. One support portion 502a contacts with the lower surface 60 on a one-end side (e.g., front side) in the width direction (in this embodiment, front-rear direction) of the aerial vehicle 1 in the state in which the aerial vehicle 1 is landed. The other support portion 502b contacts with the lower surface 60 on the other-end side (e.g., rear side) in the width direction in the state in which the aerial vehicle 1 is landed. As shown in FIG. 10, the pair of support portions 502a, 502b are provided so as to extend in a slide direction X which is a direction from the takeoff/landing portion 501 to the carry-in/out chamber 504 and is a direction opposite thereto, and are provided with an interval d therebetween in a horizontal direction Y perpendicular to the slide direction X. The interval d is greater than a width in the front-rear direction of the package chamber 10 and is smaller than a width in the front-rear direction of the body cover 51.

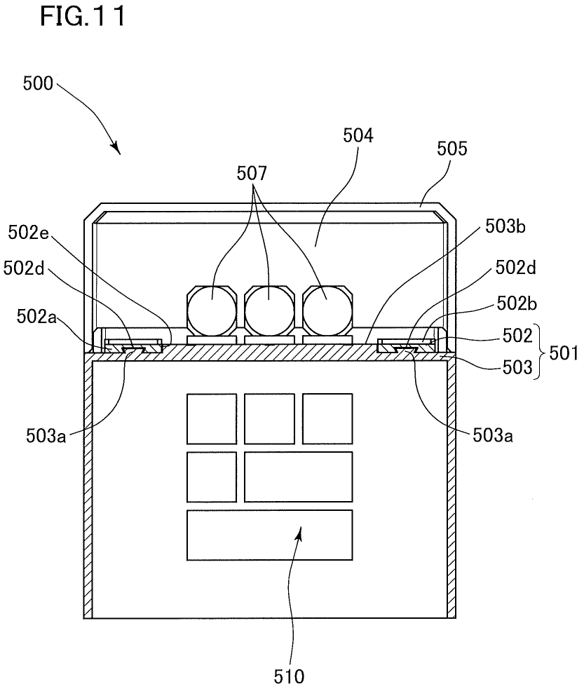

As shown in FIG. 11, each support portion 502a, 502b has, at a back surface, a fitting portion 502d fitted to a fitting portion 503a on the slider support portion 503 side. The fitting portion 502d has a recess shape extending in the slide direction X.

The slider 502 has a connection portion 502c connecting one-end sides in the slide direction X (sides far from the carry-in/out chamber 504) of the pair of support portions 502a, 502b (see FIGS. 9 and 10).

A space portion 502e forming the interval d is provided between the pair of support portions 502a, 502b and the connection portion 502c. That is, the slider 502 (support portions 502a, 502b and connection portion 502c) is provided so as to surround the periphery of the space portion 502e. The space portion 502e is formed to penetrate between front and back surfaces of the slider 502. The size (width) in the horizontal direction of the space portion 502e is greater than the size (width) in the horizontal direction of the package chamber 10 and is smaller than the size (width) in the horizontal direction of the body cover 51. In a state in which the aerial vehicle 1 is landed, the package-chamber tray 2 forming the bottom of the package chamber 10 is opposed to the space portion 502e.

The slider support portion 503 is provided across a range between the outdoor area where the takeoff/landing portion 501 is located and the carry-in/out chamber 504 (indoor). An upper surface of the slider support portion 503 forms a support surface supporting the slider 502. At the upper surface, a pair of guide portions 503a (fitting portions) for guiding movement in the slide direction X of the slider 502 are formed (see FIG. 11). One guide portion 503a is fitted to one fitting portion 502d formed at the back surface of the slider 502. The other guide portion 503a is fitted to the other fitting portion 502d formed at the back surface of the slider 502. That is, each guide portion 503a has a projection shape fitted to the fitting portion 502d having a recess shape. The guide portion 503a is formed to extend in the slide direction X across a range from the outdoor area where the takeoff/landing portion 501 is located to the carry-in/out chamber 504 (indoor).

The slider support portion 503 has an exposed surface 503b exposed from the space portion 502e of the slider 502 in a state in which the slider 502 is located in the outdoor area (see FIGS. 9 to 11). The exposed surface 503b is provided, for example, at the same height as the upper surface of the slider 502 so as to be fitted to the space portion 502e. That is, the exposed surface 503b is provided in a projection shape relative to surfaces where the guide portions 503a are formed, of the slider support portion 503. On the exposed surface 503b, an indication such as a mark representing the takeoff/landing portion 501 may be provided.

Of the slider support portion 503, a part located in the outdoor area forms a part of the takeoff/landing portion 501. In addition, the slider 502, when located in the outdoor area, forms a part of the takeoff/landing portion 501.

The carry-in/out chamber 504 is provided at a position adjacent in the slide direction X to the takeoff/landing portion 501. The carry-in/out chamber 504 forms a space for receiving (carrying in) the aerial vehicle 1 arriving at the takeoff/landing portion 501 and for sending out (carrying out) the aerial vehicle 1 after package receiving or package passing, to the takeoff/landing portion 501. In addition, the carry-in/out chamber 504 is a chamber for taking down the package 100 (package-chamber tray 2) from the aerial vehicle 1 and for remounting the package-chamber tray 2 to the aerial vehicle 1 after package receiving or package passing.

The carry-in/out chamber 504 has an outer wall 505 covering the space for receiving the aerial vehicle 1. The outer wall 505 includes a roof covering the upper side of the carry-in/out chamber 504 and a side wall covering the lateral side of the carry-in/out chamber 504. The carry-in/out chamber 504 has an opening 504a on the takeoff/landing portion 501 side (see FIG. 9). Through the opening 504a, the aerial vehicle 1 moves into the carry-in/out chamber 504 or moves out of the carry-in/out chamber 504.

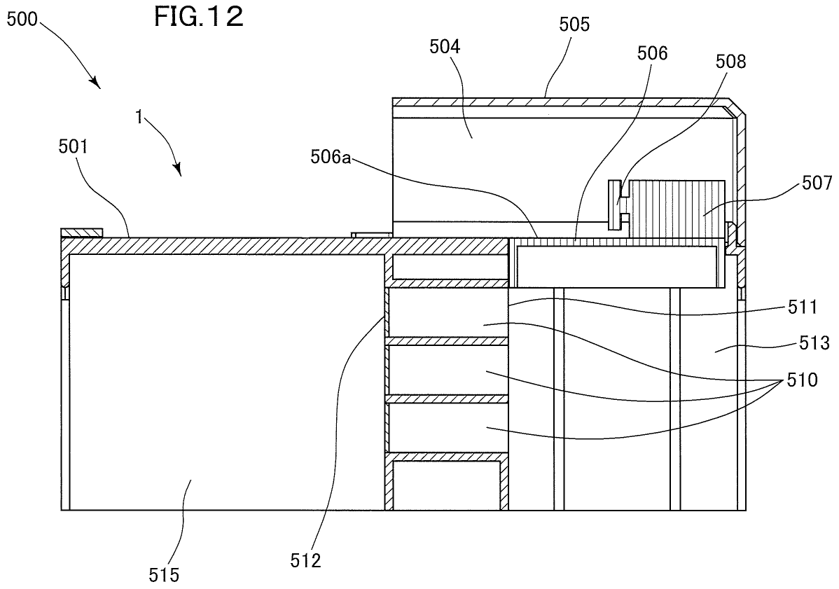

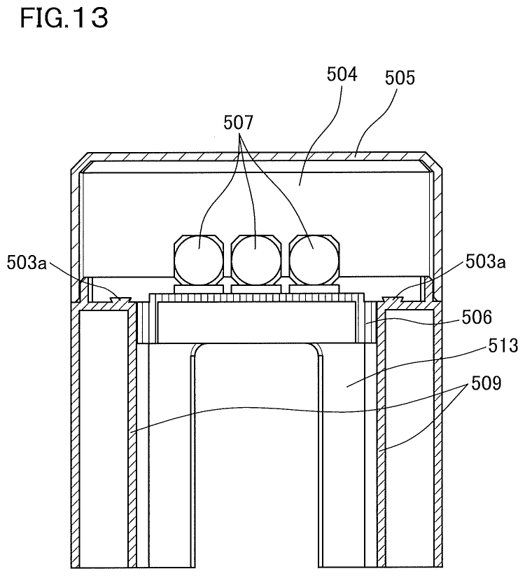

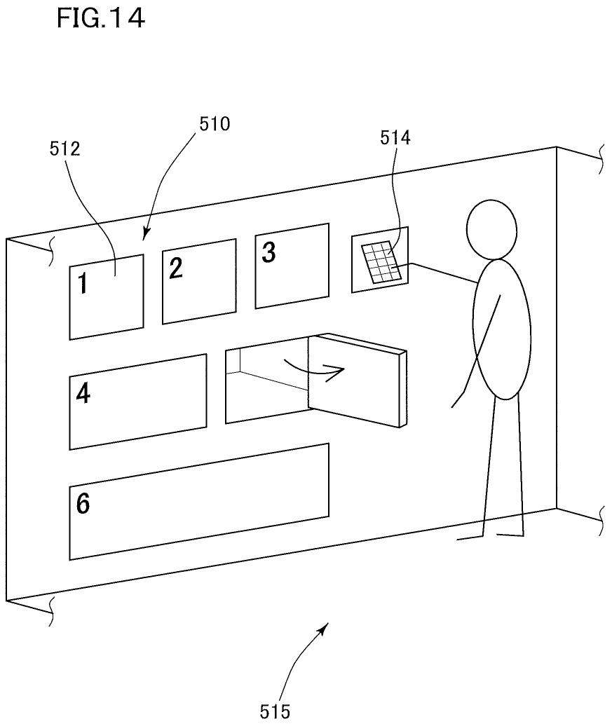

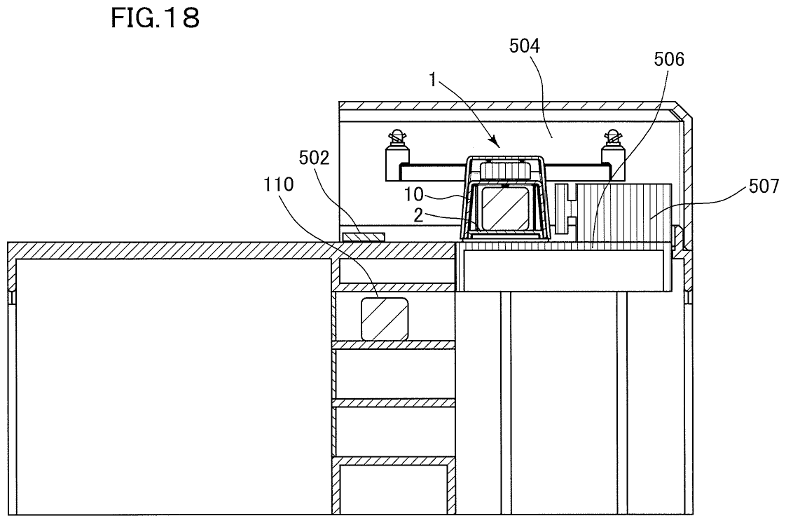

The elevating/lowering portion 506 is a table (stage) on which the package-chamber tray 2 taken down from the aerial vehicle 1 is to be placed. The elevating/lowering portion 506 has, at an upper surface, a tray-placing surface 506a (see FIG. 12) on which the package-chamber tray 2 is to be placed. The elevating/lowering portion 506 is provided so as to be movable in the up-down direction (vertical direction) between the carry-in/out chamber 504 and a lower space 513 (see FIG. 12) where the package locker 510 is located. The elevating/lowering portion 506 in a state of being located in the carry-in/out chamber 504 forms a part of a floor surface of the carry-in/out chamber 504. In addition, the elevating/lowering portion 506 in a state of being located in the carry-in/out chamber 504 is located between the pair of guide portions 503a of the slider support portion 503 (see FIG. 13). In a state in which the slider 502 is located in the carry-in/out chamber 504, the elevating/lowering portion 506 is located at the space portion 502e of the slider 502. In a state in which the aerial vehicle 1 is carried into the carry-in/out chamber 504, the elevating/lowering portion 506 is opposed to the package chamber 10 (i.e., body space 55 of aerial vehicle 1) under the package chamber 10 of the aerial vehicle 1 (see FIG. 18). The port 500 includes, at the lower space 513 of the carry-in/out chamber 504, guide portions 509 for guiding elevating/lowering movement of the elevating/lowering portion 506 (see FIG. 13).

The package moving portion 507 is a member for moving the package 100, 110 between the package locker 510 and the package-chamber tray 2 placed on the elevating/lowering portion 506. That is, the package moving portion 507 is a member for pushing out the package 100 placed on the package-chamber tray 2 on the elevating/lowering portion 506 to the package locker 510 or for drawing the package 110 stored in the package locker 510 to the package-chamber tray 2 on the elevating/lowering portion 506. The package moving portion 507 is formed by including a pushing portion for pushing out the package 100 from the elevating/lowering portion 506 to the package locker 510, and a drawing portion for drawing the package 110 from the package locker 510 to the elevating/lowering portion 506. In this case, the package moving portion 507 may be formed as a common member including the pushing portion and the drawing portion integrally, or may be formed to have the pushing portion and the drawing portion separately.

The package moving portion 507 is placed on the elevating/lowering portion 506 and is elevated/lowered along with elevating/lowering movement of the elevating/lowering portion 506. The package moving portion 507 is provided at a position adjacent to the tray-placing surface 506a (see FIG. 12) on the upper surface of the elevating/lowering portion 506. A plurality of the package moving portions 507 are provided along a direction corresponding to an arrangement direction of the packages 100 mounted to the aerial vehicle 1 or a horizontal arrangement direction of the packages 110 stored in the package lockers 510 (i.e., a horizontal arrangement direction of a plurality of comparted package lockers 510). The number of the package moving portions 507 may be the same as the number of packages that can be mounted to the aerial vehicle 1, for example. In FIG. 9, three package moving portions 507 are provided, as an example. However, the number of the package moving portions 507 may be any number corresponding to the number of packages mounted to the aerial vehicle 1. Thus, the package moving portions 507 are configured to be able to push out each package 100 individually when a plurality of packages 100 are placed on the elevating/lowering portion 506, i.e., push out one of the plurality of packages 100 to one of the plurality of comparted package lockers 510. In addition, the package moving portions 507 are configured to be able to draw each package 110 individually when a plurality of packages 110 are stored in the package locker 510, i.e., draw the package 110 from one of the plurality of comparted package lockers 510 to the elevating/lowering portion 506.

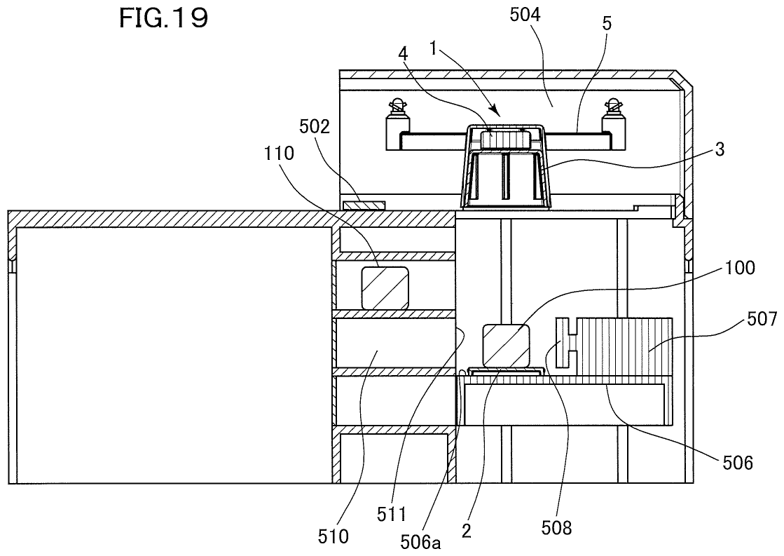

The package moving portion 507 is formed by including, for example, a pneumatic cylinder, a hydraulic cylinder, a robot hand, a vacuum pad, or the like. The package moving portion 507 has a movable portion 508 that can protrude in the horizontal direction from a retracted position (see FIG. 12). As shown in FIG. 19, when the elevating/lowering portion 506 is at a position opposed to the package locker 510, the movable portion 508 is opposed to the package locker 510 with the tray-placing surface 506a of the elevating/lowering portion 506 therebetween. The protruding direction of the movable portion 508 is set in a horizontal direction, and specifically, set in a direction of pushing the package 100 placed on the elevating/lowering portion 506 to the package locker 510 or a direction of approaching the package 110 stored in the package locker 510.

A distal end of the movable portion 508 serves as a contact portion which, when pushing the package 100 placed on the elevating/lowering portion 506, contacts with the package 100. In addition, the distal end of the movable portion 508 is formed as a holding portion which, when drawing the package 110 stored in the package locker 510, holds the package 110. The holding portion may hold the package 110 by any method, e.g., may suck the package 110 by a vacuum pad or the like, grasp the package 110 by a robot hand or the like, or hook the package 110. The package moving portion 507 may be configured to move the package 100, 110 between the package locker 510 and the elevating/lowering portion 506 (package-chamber tray 2) while keeping a bottom surface of the package 100, 110 in contact with a surface thereunder without lifting the package 100, 110, for example. However, without limitation thereto, the package moving portion 507 may be configured to move the package 100, 110 while lifting the package 100, 110. The elevating/lowering portion 506 and the package moving portion 507 correspond to a conveyance portion in this disclosure. The elevating/lowering portion 506 corresponds to a package-placing portion in this disclosure.

The package locker 510 is a package storage portion for receiving and storing the package 100 transported by the aerial vehicle 1 or for storing the package 110 deposited by a package sender. The package locker 510 is provided at a position laterally adjacent to a movement space 513 (lower space) of the elevating/lowering portion 506. There are a plurality of package lockers 510 comparted in the up-down direction and the horizontal direction. The package lockers 510 may be comparted in the same size or may be comparted in different sizes so as to be adaptable to the packages 100, 110 having various sizes. The horizontal arrangement direction of the package lockers 510 corresponds to the arrangement direction of the plurality of package moving portions 507 on the elevating/lowering portion 506.

Each package locker 510 has an opening 511 toward the elevating/lowering portion movement space 513 (see FIG. 12). Through the opening 511, the elevating/lowering portion movement space 513 and the inside of the package locker 510 communicate with each other.

Further, each package locker 510 has an opening/closing portion 512 which is openable and closable, at a lateral position different from the opening 511 (e.g., a lateral position opposite to the opening 511) (see FIGS. 12 and 14). The opening/closing portion 512 is located on the locker room 515 side. In a state in which the opening/closing portion 512 is closed, the inside of the package locker 510 is shut as seen from the locker room 515. In a state in which the opening/closing portion 512 is opened, the inside of the package locker 510 communicates with (is exposed to) the locker room 515 as seen from the locker room 515.

Each package locker 510 has a lock mechanism (not shown) for blocking the opening/closing portion 512 from being opened. The lock mechanism may be any type of mechanism, e.g., may be a mechanism that allows a lock to be electronically released by ID authentication (e.g., input of passcode number) or a mechanism that allows a lock to be released by inserting a key into a key cylinder and then turning the key. In the example in FIG. 14, an input portion 514 for inputting a number is provided at the locker room 515. When the number inputted to the input portion 514 coincides with a predetermined passcode number, the lock of the corresponding package locker 510 is released accordingly.

Each package locker 510 is assigned with information (e.g., number) for identifying the package locker 510. The identification information is displayed on each package locker 510 (e.g., opening/closing portion 512) so as to be visible from the locker room 515.

The package locker 510 serves as both of a first package storage portion for receiving the package 100 from the aerial vehicle 1 and storing the package 100, and a second package storage portion for storing the package 110 to be passed to the aerial vehicle 1. In this case, the first package storage portion and the second package storage portion may be a common package storage portion or may be provided separately. In a case of providing the first package storage portion and the second package storage portion separately, for example, the first package storage portion and the second package storage portion may be comparted on upper and lower sides in the elevating/lowering portion movement space 513.

The locker room 515 is a room where a package-receiving person receives the package 100 put into the package locker 510 from the aerial vehicle 1 or a room where a package sender or a person in charge for the port 500 deposits the carried package 110 into the package locker 510. The locker room 515 is set as a space that the opening/closing portions 512 of the package lockers 510 face. The locker room 515 is provided on a floor lower than the takeoff/landing portion 501 and the carry-in/out chamber 504, for example.

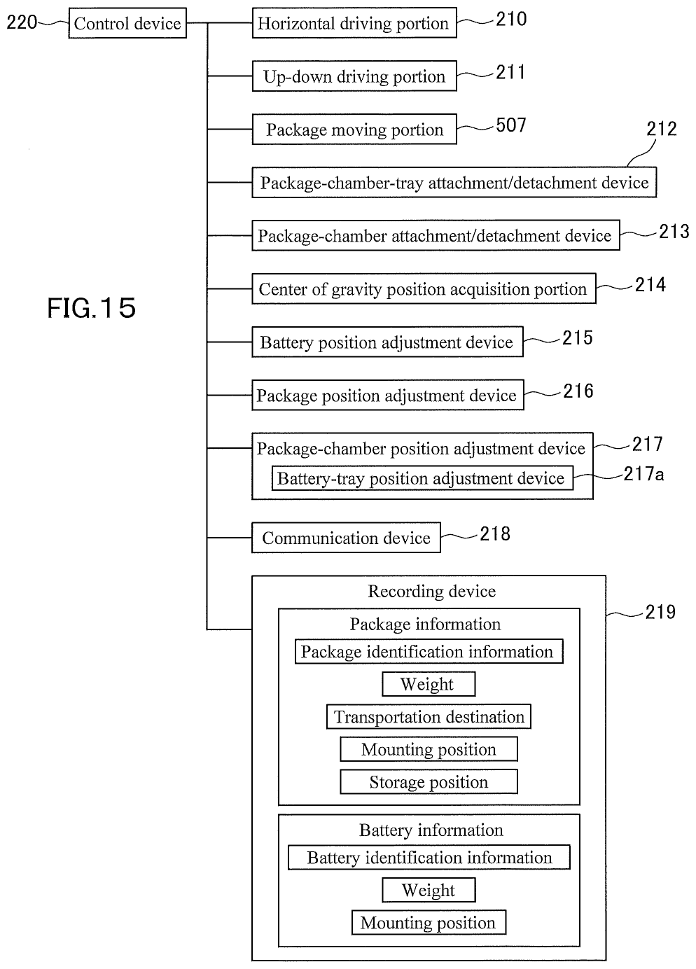

The port 500 has an electric configuration shown in FIG. 15. Specifically, the port 500 includes a horizontal driving portion 210, an up-down driving portion 211, a package moving portion 507, a package-chamber-tray attachment/detachment device 212, a package-chamber attachment/detachment device 213, a center of gravity position acquisition portion 214, a battery position adjustment device 215, a package position adjustment device 216, a package-chamber position adjustment device 217, a communication device 218, a recording device 219, and a control device 220.

The horizontal driving portion 210 is a device for moving the slider 502 horizontally in the slide direction X. The horizontal driving portion 210 is formed of a motor, a cylinder, and the like. The slider 502 and the horizontal driving portion 210 correspond to a horizontal movement portion in this disclosure.

The up-down driving portion 211 is a device for moving the elevating/lowering portion 506 in the up-down direction. The up-down driving portion 211 is formed of a motor, a cylinder, and the like.

The package moving portion 507 is provided at the elevating/lowering portion 506, and is a device for moving the package 100 between the elevating/lowering portion 506 and the package locker 510, as described above.

The package-chamber-tray attachment/detachment device 212 is provided at the carry-in/out chamber 504, and is a device (robot) for detaching the package-chamber tray 2 of the aerial vehicle 1 carried into the carry-in/out chamber 504, from the aerial vehicle 1, or attaching the detached package-chamber tray 2 to the aerial vehicle 1.

The package-chamber attachment/detachment device 213 is provided at the carry-in/out chamber 504, and is a device (robot) for detaching the package chamber 10 of the aerial vehicle 1 carried into the carry-in/out chamber 504, from the body 5, or attaching the detached package chamber 10 to the body 5.

The center of gravity position acquisition portion 214 is a device for acquiring the center of gravity position in the horizontal direction of the aerial vehicle 1. The center of gravity position acquisition portion 214 may acquire the center of gravity position of the entire package-chamber tray 2 (in a case where the package 100, 110 is placed on the package-chamber tray 2, including the package 100, 110) in a state of being separated from the package-chamber cover 3, may acquire the center of gravity position of the entire package chamber 10 (an integrated unit of the package-chamber tray 2 and the package-chamber cover 3) (in a case where the package 100, 110 is housed in the package chamber 10, including the package 100, 110) in a state of being separated from the body 5, or may acquire the center of gravity position of the entire aerial vehicle 1 having the package chamber 10 and the body 5 integrally (in a case where the package 100, 110 is mounted, including the package 100, 110). The center of gravity position acquisition portion 214 is formed as a weight-distribution measurement portion for measuring a weight distribution in the horizontal direction of a weight object placed on the elevating/lowering portion 506, for example. In this case, the center of gravity position acquisition portion 214 is formed by a pressure sensor or the like provided to the elevating/lowering portion 506.

The center of gravity position acquisition portion 214 may acquire the weight of each package 100, 110 placed on the package-chamber tray 2 and the mounting position of each package 100, 110 on the package-chamber tray 2, and then, on the basis of the acquired weight and mounting position of each package 100, 110, may calculate the center of gravity position of the package 100, 110 placed on the package-chamber tray 2 (in a case where a plurality of packages 100, 110 are placed, the center of gravity position of the entirety of the plurality of packages 100, 110). In this case, the weight of each package 100, 110 may be acquired through measurement at the time of calculation of the center of gravity position, or may be recorded in advance in the recording device 219. The mounting position of each package 100, 110 may be acquired using a sensor such as a camera, or may be recorded in advance in the recording device 219.

The battery position adjustment device 215 is a device for adjusting the mounting position of the battery 4 placed on the package chamber 10. Specifically, the battery position adjustment device 215 is provided at the carry-in/out chamber 504, and is a device (robot) for grasping the battery 4 placed on the package chamber 10 (package-chamber cover 3) and remounting the body 41 of the grasped battery 4 at any position on the upper surface of the package chamber 10.

The package position adjustment device 216 is a device for adjusting the mounting position of the package 100, 110 on the package-chamber tray 2. Specifically, the package position adjustment device 216 is provided at the carry-in/out chamber 504, and is a device (robot) for grasping the package 100, 110 placed on the package-chamber tray 2 and remounting the grasped package 100, 110 at any position on the package-chamber tray 2. In the first embodiment, it is assumed that adjustment of the mounting position of the package 100, 110 is not performed. Therefore, in the first embodiment, the package position adjustment device 216 may not be provided.

The package-chamber position adjustment device 217 is a device for adjusting the mounting position of the package chamber in the body. In the aerial vehicle 1 of the first embodiment, it is impossible to adjust the mounting position of the package chamber 10 in the body 5. That is, in the first embodiment, it is assumed that adjustment of the mounting position of the package chamber is not performed. Therefore, in the first embodiment, the package-chamber position adjustment device 217 may not be provided.

The communication device 218 is a device for communicating with an external management device (not shown). The communication device 218 receives information about the aerial vehicle 1 planned to arrive at the port 500, from the management device, for example. This information includes, for example, a planned arrival time of the aerial vehicle 1, package information about the package 100, 110 mounted to the aerial vehicle 1 or stored in the package locker 510, battery information about the battery 4 mounted to the aerial vehicle 1, and the like. The information (such as package information and battery information) received by the communication device 218 may be recorded in the recording device 219, for example. The package information and the battery information received by the communication device 218 may be information similar to package information and battery information recorded in the recording device 219 described below.

The recording device 219 is a nonvolatile recording device for recording various information therein. Specifically, the recording device 219 records therein package information about each package 100, 110 mounted to the aerial vehicle 1 or stored in the package locker 510, for example. The package information may include information about not only the package 100, 110 that is a receiving or passing target at the port 500 but also the package 100, 110 that is not a receiving or passing target.

The package information includes, for example, package identification information (such as ID number) for identifying each package 100, 110, information indicating the weight of each package 100, 110, information indicating the transportation destination of each package 100, 110 (e.g., address, or location of port 500), information indicating the mounting position of each package 100 on the package-chamber tray 2 in a case where a plurality of packages 100 are mounted on the package-chamber tray 2, storage-position information indicating in which package locker 510 the package 100 is to be stored in a case of storing (receiving) the package 100 in the package locker 510, storage-position information indicating in which package locker 510 the package 110 has been stored in a case of passing the package 110 to the aerial vehicle 1, and the like. The information indicating the mounting position may be information indicating at which position each package 100 is mounted among front, center, and rear positions on the package-chamber tray 2 in a case where three packages 100 are arranged in the front-rear direction on the package-chamber tray 2, for example.

The storage-position information may be identification information assigned to each package locker 510, for example. The package identification information and other pieces of information (such as weight, transportation destination, mounting position, and storage position) are recorded in association with each other in the recording device 219.

In addition, the recording device 219 records therein battery information about the battery 4 mounted to the aerial vehicle 1. The battery information includes, for example, battery identification information (such as ID number) for identifying each battery 4, information indicating the weight of the battery 4, information indicating the mounting position of the body 41 of the battery 4 on the upper surface of the package chamber 10, and the like. The battery identification information and other pieces of information (such as weight and mounting position) are recorded in association with each other in the recording device 219.

The control device 220 is a device for controlling the devices 210 to 219, 507 shown in FIG. 15.

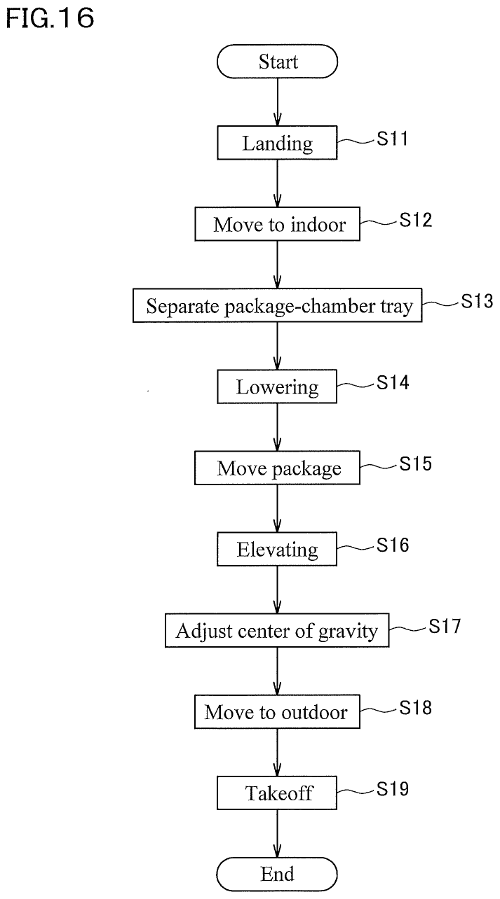

Next, a package receiving or passing method for the package 100 at the port 500 will be described. FIG. 16 shows a flowchart of the method. The process in FIG. 16 is executed by the control device 220 in FIG. 15, for example.

First, the aerial vehicle 1 is landed on the takeoff/landing portion 501 (S11). At this time, the control device 220 controls the horizontal driving portion 210 to move the slider 502 to the position of the takeoff/landing portion 501 in advance. FIG. 17 shows a state in which the aerial vehicle 1 is landed on the takeoff/landing portion 501.

Next, the control device 220 controls the horizontal driving portion 210 to move the slider 502 on which the aerial vehicle 1 is placed to the carry-in/out chamber 504 (indoor) (S12). FIG. 18 shows a state in which the aerial vehicle 1 is moved to the carry-in/out chamber 504. In this state, the elevating/lowering portion 506 is located under the package-chamber tray 2 mounted to the aerial vehicle 1.

Next, the control device 220 controls the package-chamber-tray attachment/detachment device 212 to separate the package-chamber tray 2 downward from the aerial vehicle 1 moved to the carry-in/out chamber 504 and place, on the elevating/lowering portion 506, the separated package-chamber tray 2 and the package 100 placed thereon (S13). In a state in which the package-chamber tray 2 is placed on the elevating/lowering portion 506, each package 100 is located in front of the movable portion 508 of the corresponding package moving portion 507. In a case of passing the package 110 to the aerial vehicle 1 from the port 500, the package 100 may not be placed on the package-chamber tray 2 at the time of step S13.

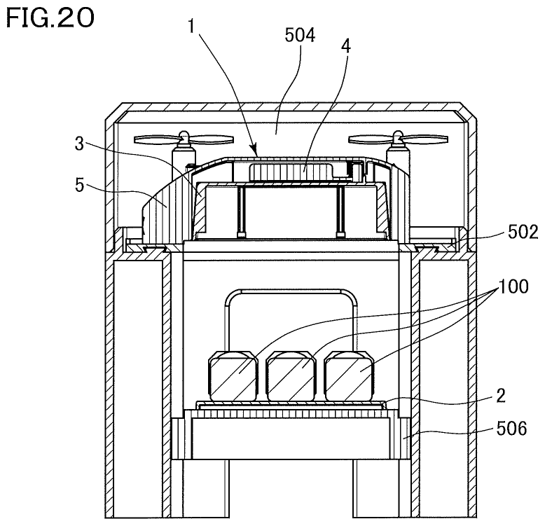

Next, the control device 220 controls the up-down driving portion 211 to lower the elevating/lowering portion 506 on which the package-chamber tray 2 and the package 100 are placed, to a position opposed to the package locker 510 which is to be used for package receiving at this time or in which the passing-target package 110 is stored (S14). Which of the plurality of comparted package lockers 510 is to be used for package receiving may be determined in any manner. FIGS. 19 and 20 show a state in which the elevating/lowering portion 506 is lowered to a position opposed to the package locker 510 to be used for package receiving. In this state, the aerial vehicle 1 (body 5, battery 4, and package-chamber cover 3) from which the package-chamber tray 2 has been taken down is left in the carry-in/out chamber 504. Specifically, for example, the aerial vehicle 1 remains placed on the slider 502. In the example in FIG. 19, the passing-target package 110 is stored in the package locker 510 different from the package locker 510 to be used for package receiving.

Next, the control device 220 controls the package moving portion 507 to push out the package 100 placed on the package-chamber tray 2 to the package locker 510 so as to put the package 100 into the package locker 510, or draw the package 110 stored in the package locker 510 onto the package-chamber tray 2 (S15). At this time, in a case where a plurality of packages 100 are placed on the package-chamber tray 2, the control device 220 specifies, among the plurality of packages 100, one or a plurality of receiving-target packages 100. Specifically, the control device 220 determines whether transportation destination information included in the package information recorded in the recording device 219 is information indicating the port 500 or information indicating another location, for example. Then, the control device 220 determines that the package 100 for which the transportation destination indicates the port 500 is the receiving-target package. In addition, the control device 220 determines at which position the receiving-target package 100 is placed on the package-chamber tray 2, on the basis of mounting position information included in the package information recorded in the recording device 219, for example. In addition, the control device 220 specifies the package locker 510 in which the passing-target package 110 is stored, on the basis of the package information recorded in the recording device 219, for example.

Then, the control device 220 drives the package moving portion 507 opposed to the specified receiving-target package 100 among the plurality of package moving portions 507 provided to the elevating/lowering portion 506. Thus, the receiving-target package 100 is put into the package locker 510 from the package-chamber tray 2 (elevating/lowering portion 506), while the package 100 that is not a receiving target is left on the package-chamber tray 2 (elevating/lowering portion 506). As shown in FIG. 19, in a case where there is the passing-target package 110, the control device 220 moves the elevating/lowering portion 506 to a position opposed to the package 110, and then drives the package moving portion 507 opposed to the package 110, to draw the package 110 from the package locker 510 onto the package-chamber tray 2.

In a case where there are a plurality of receiving-target packages 100, these may be received in the package lockers 510 located at the same height among the plurality of package lockers 510 comparted in the height direction and the horizontal direction, or may be received in the package lockers 510 located at different heights. The package 100 may be received in the package locker 510 located at the same height position as the package locker 510 in which the passing-target package 110 is stored, or may be received in the package locker 510 located at a height position different therefrom. In a case where there are a plurality of receiving-target packages 100, a plurality of package moving portions 507 may be driven at the same time to put the plurality of packages 100 into respective package lockers 510 at the same time, or may be driven at different times to put the plurality of packages 100 into respective package lockers 510 at different times. In a case where there are a plurality of passing-target packages 110, a plurality of package moving portions 507 may be driven at the same time to draw the plurality of packages 110 onto the package-chamber tray 2 at the same time, or may be driven at different times to draw the plurality of packages 110 onto the package-chamber tray 2 at different times.

When the package 100 is put into the package locker 510, a receiving person for the package 100 may be notified that the package 100 has arrived at the port 500, and may be notified about in which package locker 510 the package 100 is stored. The above notification to the receiving person may be performed by any means such as e-mail. The notified receiving person can receive the package 100 by opening the corresponding package locker 510 in the locker room 515 of the port 500.

Returning to FIG. 16, next, the control device 220 controls the up-down driving portion 211 to elevate the elevating/lowering portion 506 to the position of the carry-in/out chamber 504 (S16).

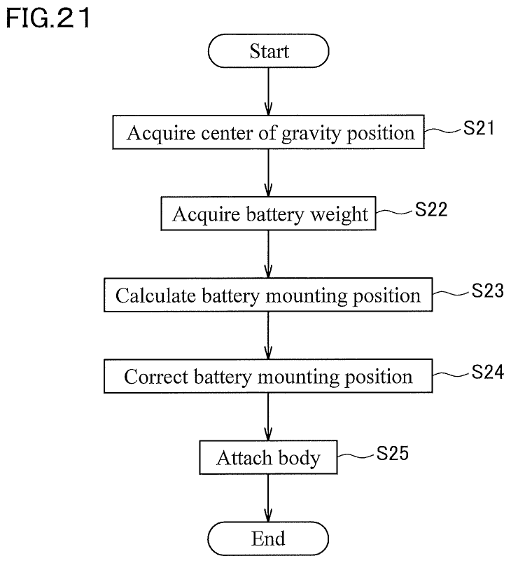

Next, the center of gravity position of the aerial vehicle 1 after receiving/passing of the package 100, 110 is adjusted to be an optimum center of gravity position (S17). Specifically, in step S17, for example, a process in FIG. 21 is executed. In FIG. 21, first, the control device 220 causes the center of gravity position acquisition portion 214 in FIG. 15 to measure or calculate the center of gravity position of the aerial vehicle 1 after receiving/passing of the package 100, 110, and acquires the center of gravity position from the center of gravity position acquisition portion 214 (S21). At this time, as described above, the center of gravity position acquisition portion 214 may acquire, as the center of gravity position, the weight distribution in the horizontal direction of the package-chamber tray 2 (in a case where the package 100 is left or the package 110 is newly mounted, including the package 100, 110) in a state of being separated from the package-chamber cover 3, may acquire the weight distribution in the horizontal direction of an integrated unit of the package-chamber tray 2 and the package-chamber cover 3 (in a case where the package 100 is left or the package 110 is newly mounted, including the package 100, 110), or may acquire the weight distribution in the horizontal direction of an integrated unit of the package chamber 10 and the body 5 (in a case where the package 100 is left or the package 110 is newly mounted, including the package 100, 110). The center of gravity position acquisition portion 214 may acquire, as the center of gravity position, the weight distribution in the horizontal direction of the package chamber 10 at which the battery 4 is placed (in a case where the package 100 is left or the package 110 is newly mounted, including the package 100, 110), or may acquire the weight distribution in the horizontal direction of an integrated unit of the body 5 and the package chamber 10 at which the battery 4 is placed (in a case where the package 100 is left or the package 110 is newly mounted, including the package 100, 110).

In step S21, in a case where the package 100, 110 is placed on the package-chamber tray 2, the center of gravity position of the aerial vehicle 1 may be acquired in a state in which the mounting position of the package 100, 110 on the package-chamber tray 2 is kept at the original position (the mounting position at the time of landing in step S11 or the position of the package 110 on the package-chamber tray 2 when the package 110 has been moved from the package locker 510 onto the package-chamber tray 2 in step S15), or if the mounting position of the package 100, 110 is changed from the original position, the center of gravity position of the aerial vehicle 1 may be acquired in a state after the position change. In step S21, in a case where no package 100 is left on the package-chamber tray 2 and there is no package 110 to be newly mounted, the center of gravity position (weight distribution) of the aerial vehicle 1 is acquired in a state in which there is no package 100, 110.

Next, the control device 220 acquires the weight of the battery 4 mounted to the aerial vehicle 1 (S22). As the weight of the battery 4, for example, the weight recorded in the recording device 219 may be read.

Next, the control device 220 calculates an optimum mounting position of the battery 4 on the upper surface of the package chamber 10, on the basis of the center of gravity position after package receiving/passing acquired in step S21 and the weight of the battery 4 acquired in step S22 (S23). At this time, the control device 220 calculates such a mounting position of the battery 4 that the center of gravity position in the horizontal direction of the package chamber 10 or the aerial vehicle 1 (an integrated unit of the package chamber 10 and the body 5) in a state in which the battery 4 is mounted on the upper surface of the package chamber 10 becomes a predetermined target center of gravity position, for example. As the mounting position of the battery 4, for example, the center position or the center of gravity position of the battery body 41 on the upper surface of the package chamber 10 is calculated. The target center of gravity position is set at the center of the package chamber 10, for example.

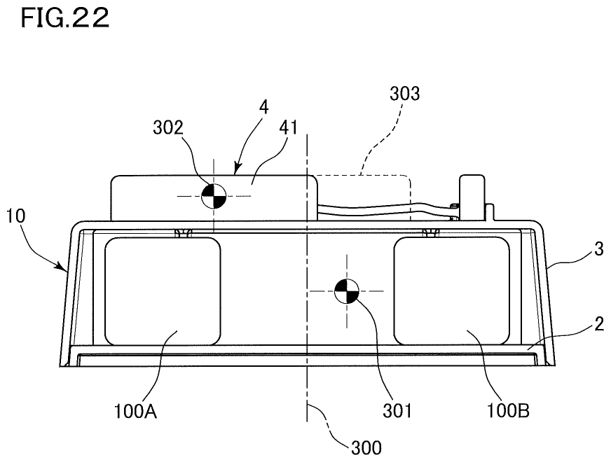

For example, in FIG. 22, two packages 100A, 100B are left on the package-chamber tray 2 (package chamber 10), the weight of the package 100B is greater than the weight of the package 100A, and the packages are arranged in the front-rear direction in the order of package 100A, package 100B. A center of gravity position denoted by a reference character “301” is the center of gravity position acquired in step S21, and a position denoted by a reference character “300” is the target center of gravity position in the front-rear direction. A position denoted by a reference character “302” is the optimum mounting position of the battery 4 calculated in step S23 (i.e., the center position or the center of gravity position of the battery 4). Since the package 100B is heavier than the package 100A, the center of gravity position 301 is shifted toward the package 100B from the target center of gravity position 300. In this case, the optimum mounting position 302 of the battery 4 is calculated to be a position shifted toward the package 100A from the target center of gravity position 300. At this time, as the shift amount of the center of gravity position 301 from the target center of gravity position 300 increases, the shift amount of the optimum mounting position 302 of the battery 4 from the target center of gravity position 300 also increases. As the weight of the battery 4 increases, the optimum mounting position 302 of the battery 4 may be set at a position closer to the target center of gravity position 300.

FIG. 22 has shown the example in which the optimum mounting position 302 of the battery 4 is changed in the front-rear direction among horizontal directions, in accordance with the weight of the battery 4 and the center of gravity position 301 of the aerial vehicle 1 (packages 100). In a case where the center of gravity position 301 is shifted in the left-right direction from the target center of gravity position 300, the optimum mounting position 302 of the battery 4 is also shifted in the left-right direction from the target center of gravity position 300.

Here, the center of gravity position (weight distribution) acquired in step S21 changes in accordance with the weight of each package 100, 110 left on the package-chamber tray 2 or newly mounted thereon and the mounting position of each package 100, 110 on the package-chamber tray 2. Therefore, the optimum mounting position acquired in step S23 changes in accordance with the weight of each package 100, 110 left on the package-chamber tray 2 or newly mounted thereon, the mounting position of each package 100, 110 on the package-chamber tray 2, and the weight of the battery 4. That is, the processing in step S23 is the same as processing of calculating the optimum mounting position of the battery 4 on the basis of the weight of each package 100, 110 placed on the package-chamber tray 2, the mounting position of each package 100, 110 on the package-chamber tray 2, and the weight of the battery 4.

Returning to FIG. 21, next, the control device 220 corrects the mounting position of the battery 4 on the upper surface of the package chamber 10, to the optimum mounting position calculated in step S23 (S24). Specifically, the control device 220 controls the package-chamber attachment/detachment device 213 (see FIG. 15) to detach the package chamber 10 (package-chamber cover 3) from the body 5. Then, the control device 220 controls the battery position adjustment device 215 to grasp the body 41 of the battery 4 placed on the detached package-chamber cover 3 and move the position of the grasped battery body 41 to the optimum mounting position calculated in step S23. In FIG. 22, a reference character “303” denotes the original mounting position of the battery 4. In step S24, the mounting position of the battery body 41 is corrected from the position denoted by the reference character “303” to the position denoted by the reference character “302”.

Next, the control device 220 performs control to attach the package chamber 10 on which the battery 4 is placed, to the body 5 (S25). Specifically, the control device 220 controls the package-chamber-tray attachment/detachment device 212 and the package-chamber attachment/detachment device 213 (see FIG. 15) to integrate the package-chamber tray 2 and the package-chamber cover 3 and integrate the package-chamber cover 3 and the body 5 (S25). Thus, the center of gravity position of the aerial vehicle 1 after package receiving/passing can be set at an optimum center of gravity position (target center of gravity position).

Returning to FIG. 16, next, the control device 220 controls the horizontal driving portion 210 to move the slider 502 on which the aerial vehicle 1 with the center of gravity position adjusted is placed, to the outdoor area where the takeoff/landing portion 501 is located (S18). Then, the control device 220 causes the aerial vehicle 1 to take off toward the next destination (S19). At this time, in a case where the package 100, 110 is mounted to the aerial vehicle 1, the aerial vehicle 1 flies to the transportation destination of the package 100, 110. In a case where no package 100, 110 is mounted to the aerial vehicle 1, the aerial vehicle 1 returns to the base.

The battery position adjustment device 215 and the control device 220 for executing step S17 in FIG. 16 (specifically, steps S21 to S25 in FIG. 21) correspond to a center of gravity adjustment portion and a battery position adjustment portion in this disclosure. Step S17 in FIG. 16 corresponds to a center of gravity adjustment step in this disclosure. The up-down driving portion 211 and the control device 220 for executing step S14 and step S16 in FIG. 16 correspond to a movement control portion. The up-down driving portion 211 and the control device 220 for executing step S14 correspond to a first movement control portion. The up-down driving portion 211 and the control device 220 for executing step S16 correspond to a second movement control portion. Steps S12 to S16 correspond to a package receiving or passing step. Steps S18 and S19 correspond to a takeoff step. Step S14 corresponds to a first conveyance step. Step S15 corresponds to a package movement step. Step S16 corresponds to a second conveyance step.

Hereinafter, effects of the first embodiment will be described. Since the package chamber 10 is attachable and detachable to and from the body 5 of the aerial vehicle 1, the package chamber 10 with the package 100 and the battery 4 mounted thereto can be prepared in advance (can be initially set up) before preparation of the body 5. Thus, when the body 5 has been prepared, the package 100 and the battery 4 can be immediately mounted to the body 5, whereby the mounting work time can be shortened. In addition, the package 100 and the battery 4 can be mounted to the body 5 at the same time. Since the package chamber 10 with the battery 4 and the package 100 mounted thereto can be initially set up, operation management for the aerial vehicle 1 at the base is facilitated, and for example, the body 5 having returned to the base can be immediately integrated with the next package chamber 10 so as to fly. Thus, the aerial vehicles 1 (body 5) can take off sequentially without waiting time, whereby the turnover (operation rate) of the body 5 can be increased.

The package-chamber tray 2 (placement portion for package 100) of the package chamber 10 can be separated from the package-chamber cover 3. Therefore, in a state of being separated from the package-chamber cover 3, the package 100 can be placed on the package-chamber tray 2 and the package 100 placed on the package-chamber tray 2 can be taken down. Thus, loading and unloading of the package 100 can be efficiently performed. In addition, such a package-chamber structure that it is easy for a robot to automatically perform loading and unloading of the package 100, can be provided. Further, separating the package-chamber tray 2 from the package-chamber cover 3 makes it easy to place a plurality of packages 100 on the package-chamber tray 2 and also makes it easy to adjust the mounting position of the package 100 on the package-chamber tray 2.

The package-chamber cover 3 is attached to the package-chamber tray 2 from above and is separated upward of the package-chamber tray 2. Therefore, it is easy for a robot to automatically perform attachment and detachment of the package-chamber cover 3 to and from the package-chamber tray 2.

Since the package-chamber space 35 of the package chamber 10 is a space closed on all sides, the package 100 can be protected from rain (water) and the like. In addition, since the package chamber 10 does not have an opening/closing portion on a side other than the lower side, rain water can be prevented from entering the package-chamber space 35 through a gap of the opening/closing portion of the package chamber 10.

The tray body 21 of the package-chamber tray 2 in a state of being attached to the package-chamber cover 3 is located on the inner side of the package-chamber space 35 relative to the downward opening 34 of the package-chamber cover 3 (see FIGS. 2 and 3). Therefore, the package 100 placed on the tray body 21 can be further protected from rain and the like. Further, in a state in which the package-chamber tray 2 is attached to the package-chamber cover 3, the entire periphery of the outer-periphery portion 22 of the package-chamber tray 2 contacts with the inner surface 32a of the side-surface portion 32 of the package-chamber cover 3, that is, the outer side of the outer-periphery portion 22 is covered by the side-surface portion 32. Therefore, the package 100 placed on the tray body 21 can be further protected from rain and the like.

Since the package chamber 10 in a state of being attached to the body 5 is housed in the space 55 of the body cover 51, the package 100 housed in the package chamber 10 can be further protected from rain and the like. Since the body space 55 is closed on the sides other than the lower side, rain falling from above can be prevented from entering the body space 55.

The body 5 is attached to the package chamber 10 from above and is separated upward of the package chamber 10. Therefore, it is easy for a robot to automatically perform attachment and detachment of the body 5 to and from the package chamber 10.

The parts 2, 3, 4, 5 constituting the aerial vehicle 1 are structured as nested boxes integrated by being sequentially attached from above. Therefore, the integration work is easy and waterproof property against rain can be obtained.

The battery 4 is mounted on the upper surface of the package chamber 10. Therefore, in a state in which the package chamber 10 is separated from the body 5, mounting of the battery 4 can be performed and retrieval of the battery 4 from the package chamber 10 can be performed. Thus, mounting and retrieval of the battery 4 can be facilitated. In addition, adjustment for the mounting position of the battery 4 can also be facilitated.

The battery 4 is selected in consideration of the weight of the package 100 housed in the package chamber 10 and the planned flight distance. Therefore, the battery 4 can be prevented from being charged or replaced during transportation. Thus, the body 5 of the aerial vehicle 1 can be efficiently used. In addition, the battery 4 having a greater weight (higher capacity) than necessary can be prevented from being mounted. Thus, flight can be prevented from becoming unstable due to the weight of the battery 4, and fuel consumption (power consumption of battery 4) during flight can be reduced owing to weight reduction, leading to increase in the flight distance.

Since the mounting position of the battery 4 can be adjusted, the center of gravity position of the aerial vehicle 1 can be set at an optimum position, whereby flight can be stabilized. In addition, since flight is stabilized, the rotary blades 53 can be prevented from unnecessarily rotating for orientation control of the aerial vehicle 1, whereby fuel consumption during flight can be reduced, leading to increase in the flight distance. Since the aerial vehicle 1 does not have a mechanism (electric portion such as servomotor) for adjusting the mounting position of the battery 4, the structure of the aerial vehicle 1 can be simplified and the weight of the aerial vehicle 1 can be reduced. Further, since the mounting position of the battery 4 is adjusted in initial setup before the body 5 and the package chamber 10 are integrated, the center of gravity position of the entire aerial vehicle 1 when the package chamber 10 with the package 100 and the battery 4 mounted thereto is integrated with the body 5 can be determined in the initial setup. Thus, center of gravity adjustment for the aerial vehicle 1 can be efficiently performed.

In a state of being mounted to the body 5, the battery 4 is housed in the space 58 between the upper surface of the package chamber 10 and the wall surface of the body space 55, whereby the battery 4 can be protected from rain and the like.

Since the connector holder 38 provided to the package-chamber cover 3 is located at a position opposed to the connector 59 provided to the body 5, the connector 43 of the battery 4 and the connector 59 of the body 5 can be automatically connected when the package chamber 10 and the body 5 are integrated.

The package 100 mounted to the aerial vehicle 1 can be automatically received at the aerial-vehicle port 500, or the package 110 (see FIGS. 17 to 19) stored at the aerial-vehicle port 500 can be automatically passed to the aerial vehicle 1. At the port 500, receiving/passing of the package 100, 110 is performed in a state in which the package-chamber tray 2 is separated from the aerial vehicle 1, and therefore the receiving/passing is facilitated. The receiving-target package 100 remains placed on the package-chamber tray 2 until being put into the package locker 510, and the package 100 that is not a receiving target also remains placed on the package-chamber tray 2. Therefore, unloading of the package 100 from the aerial vehicle 1 and remounting of the package 100 to the aerial vehicle 1 are facilitated.

The package 100, 110 is put into the package locker 510 or placed onto the package-chamber tray 2 through pushing or drawing operation by the package moving portion 507, and the package 100, 110 need not be grasped and lifted by a robot hand. Therefore, the mechanism for moving the package 100, 110 between the package-chamber tray 2 and the package locker 510 can be simplified and it is easy to automatically perform work for moving the package 100, 110.

The plurality of package moving portions 507 are provided along a direction corresponding to the arrangement direction of the packages 100 on the package-chamber tray 2. Therefore, in a case where a plurality of packages 100 are placed on the package-chamber tray 2, it is also possible to put only one or some of the plurality of packages 100 into the package lockers 510 and it is also possible to put all the packages 100 into the package lockers 510 different from each other. The plurality of package moving portions 507 are provided along the horizontal arrangement direction of the packages 110 in the package lockers 510. Therefore, it is possible to select whether or not to individually pass one or a plurality of packages 110 stored in the package lockers 510.

At the port 500, the center of gravity position of the aerial vehicle 1 after package receiving/passing is adjusted. Therefore, even if the weight balance of the aerial vehicle 1 is changed due to the package receiving/passing, flight of the aerial vehicle 1 after the package receiving/passing can be stabilized.

No roof is provided to the takeoff/landing portion 501. Therefore, landing and takeoff are facilitated. The aerial vehicle 1 landed on the takeoff/landing portion 501 is moved by the slider 502 into the carry-in/out chamber 504 having a roof. Therefore, the package and the battery 4 mounted to the aerial vehicle 1 can be protected from rain, wind, and the like.

The elevating/lowering portion 506 is provided at a position opposed, from the underside, to the package-chamber tray 2 mounted to the aerial vehicle 1 when the aerial vehicle 1 is placed in the carry-in/out chamber 504. Therefore, the package-chamber tray 2 separated downward from the aerial vehicle 1 can be easily placed on the elevating/lowering portion 506, and the package-chamber tray 2 after package receiving or package passing can be easily attached to the aerial vehicle 1.

### Second Embodiment

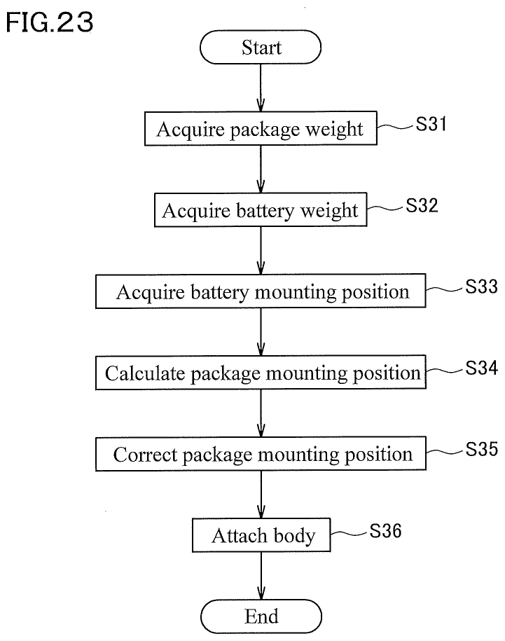

Next, a second embodiment of this disclosure will be described focusing on difference from the first embodiment. The first embodiment has shown the example in which the mounting position of the battery 4 is adjusted in step S17 in FIG. 16. In this embodiment, an example in which the mounting position of the package is adjusted in step S17 in FIG. 16 will be described. In this embodiment, as step S17 in FIG. 16, a process in FIG. 23 is executed instead of or in addition to the process in FIG. 21. In addition, the port 500 in this embodiment has the electric configuration shown in FIG. 15, as in the first embodiment. In this embodiment, the port 500 includes the package position adjustment device 216 but may not include the battery position adjustment device 215 and the package-chamber position adjustment device 217. The matters other than the process in FIG. 23 and the package position adjustment device 216 are the same as in the first embodiment.

Hereinafter, the process in FIG. 23 will be described. The process in FIG. 23 is executed by the control device 220 in FIG. 15, for example. As a premise in this embodiment, at the time when the aerial vehicle 1 has arrived at the port 500, there are a plurality of packages 100 mounted to the aerial vehicle 1 (package-chamber tray 2). In addition, in step S15 in FIG. 16, only one or some of the plurality of packages 100 are put into the package lockers 510, and at the time of center of gravity adjustment in step S17, one or a plurality of packages 100 are left on the package-chamber tray 2. Alternatively, in step S15 in FIG. 16, the package 110 is newly mounted onto the package-chamber tray 2 on the elevating/lowering portion 506 from the package locker 510.

In the process in FIG. 23, the weight of each package 100 left on the package-chamber tray 2 or each package 110 newly mounted thereon is acquired (S31). As the weight of the package 100, 110, for example, a value recorded in advance in the recording device 219 (see FIG. 15) may be acquired, or a value measured by a weight measurement device may be acquired during execution of the process in FIG. 23.

In addition, the weight of the battery 4 placed on the package chamber 10 is acquired (S32). As the weight of the battery 4, for example, a value recorded in advance in the recording device 219 (see FIG. 15) may be acquired, or a value measured by a weight measurement device may be acquired during execution of the process in FIG. 23.

Further, the mounting position of the battery 4 on the upper surface of the package chamber 10 is acquired (S33). As the mounting position of the battery 4, for example, a value recorded in advance in the recording device 219 (see FIG. 15) may be acquired, or a value measured by a camera or the like may be acquired during execution of the process in FIG. 23. In a case of changing the mounting position of the battery 4 from the original position (mounting position at the time of landing in step S11), the changed mounting position is acquired in step S33. Steps S31 to S33 may be executed in any order.

Next, on the basis of the weight of each package 100, 110, the weight of the battery 4, and the mounting position of the battery 4 acquired in steps S31 to S33, an optimum mounting position of each package 100, 110 on the package-chamber tray 2 is calculated (S34). Specifically, the control device 220 calculates, as the optimum mounting position, such a mounting position of each package 100, 110 on the package-chamber tray 2 that the center of gravity position in the horizontal direction of the entire aerial vehicle 1 (packages 100, 110, package-chamber tray 2, package-chamber cover 3, battery 4, and body 5) or the entire package chamber 10 (packages 100, 110, package-chamber tray 2, package-chamber cover 3, and battery 4) after the packages 100, 110 are remounted becomes a predetermined target center of gravity position.

Next, the control device 220 controls the package position adjustment device 216 (see FIG. 15) to correct the mounting position of each package 100, 110 left on the package-chamber tray 2 or newly mounted thereon, to the optimum mounting position calculated in step S34 (S35).

Then, the control device 220 controls the package-chamber-tray attachment/detachment device 212 in FIG. 15 to attach the package-chamber tray 2 on which the packages 100, 110 are placed, to the package-chamber cover 3 that remains attached to the body 5, thereby attaching the package chamber 10 in which the packages 100, 110 are housed, to the body 5 (S36). In a case where the package-chamber cover 3 has been detached from the body 5, the control device 220 controls the package-chamber-tray attachment/detachment device 212 and the package-chamber attachment/detachment device 213 in FIG. 15 to integrate the package-chamber tray 2 and the package-chamber cover 3 and integrate the package-chamber cover 3 and the body 5.

As described above, the center of gravity position of the aerial vehicle 1 after package receiving/passing can be set at an optimum center of gravity position (target center of gravity position). Thus, also in this embodiment, the same effects as in the first embodiment can be obtained. In addition, the mounting position of the package 100, 110 is adjusted in initial setup before the body 5 and the package chamber 10 are integrated, whereby the center of gravity position of the entire aerial vehicle 1 when the package chamber 10 with the package 100, 110 and the battery 4 mounted thereto is integrated with the body 5 can be determined in the initial setup. Thus, center of gravity adjustment for the aerial vehicle 1 can be efficiently performed.

The package position adjustment device 216 and the control device 220 for executing steps S31 to S36 in FIG. 23 correspond to a center of gravity adjustment portion and a package position adjustment portion in this disclosure. Steps S31 to S36 correspond to a center of gravity adjustment step in this disclosure.

### Third Embodiment

Next, a third embodiment of this disclosure will be described focusing on difference from the first and second embodiments. The first and second embodiments have shown the examples in which the mounting position of the battery 4 or the mounting position of the package 100, 110 is adjusted in step S17 in FIG. 16. In this embodiment, an example in which the mounting position of the package chamber in the body is adjusted in step S17 in FIG. 16 will be described.

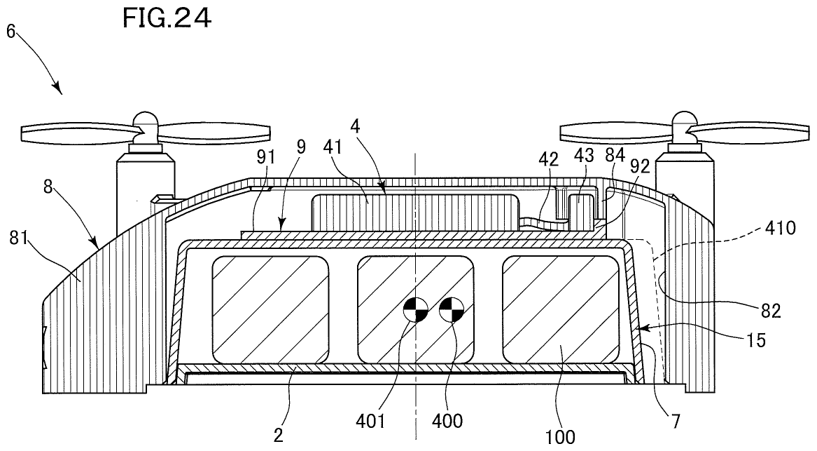

FIG. 24 shows a sectional view of an unmanned aerial vehicle according to this embodiment. In FIG. 24, the same parts as those in the first and second embodiments are denoted by the same reference characters. An aerial vehicle 6 in FIG. 24 includes the package-chamber tray 2, a package-chamber cover 7, the battery 4, and a body 8, as in the first and second embodiments. Further, the aerial vehicle 6 includes a battery tray 9.

The package-chamber tray 2 and the battery 4 are the same as the package-chamber tray 2 and the battery 4 in the first and second embodiments.

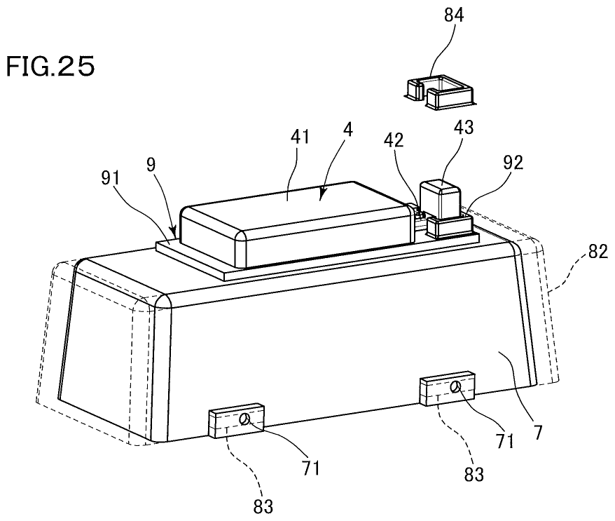

The package-chamber cover 7 is provided so as to be attachable and detachable to and from a body cover 81 of the body 8. The package-chamber cover 7 includes attachment portions 71 (see FIG. 25) to be attached to attachment portions 83 (see FIG. 25) provided to the body cover 81 when the package-chamber cover 7 is attached to the body cover 81. The attachment portions 71 are different from the attachment portions 37 (see FIGS. 4 and 5) in the first and second embodiments in that the attachment portions 71 have a function for adjusting the mounting position of the package-chamber cover 7 in a space 82 (body space) of the body cover 81, together with the attachment portions 83 of the body cover 81. Except for the attachment portions 71, the structure of the package-chamber cover 7 is the same as that of the package-chamber cover 3 in the first and second embodiments. The package-chamber tray 2 and the package-chamber cover 7 form a package chamber 15.

The body space 82 is configured to allow adjustment of the mounting position in the horizontal direction of the package-chamber cover 7. Specifically, as shown in FIGS. 24 and 25, the width in the front-rear direction (advancement direction of aerial vehicle 6) of the body space 82 is greater than the width in the front-rear direction of the package-chamber cover 7. That is, the mounting position in the front-rear direction of the package-chamber cover 7, in the body space 82, can be adjusted. In this embodiment, the width in the left-right direction of the body space 82 is the same as the width in the left-right direction of the package-chamber cover 7. However, the width in the left-right direction of the body space 82 may be set to be greater than the width in the left-right direction of the package-chamber cover 7, whereby the mounting position in the left-right direction of the package-chamber cover 7 can also be adjusted. The mounting position in the front-rear direction of the package-chamber cover 7, in the body space 82, may be unable to be adjusted, and the mounting position in the left-right direction of the package-chamber cover 7 may be able to be adjusted.

The attachment portions 83 to be attached to the attachment portions 71 of the package-chamber cover 7 are provided at wall surfaces of the body space 82 (see FIG. 25). The attachment portions 83 are different from the attachment portions 57 (see FIG. 5) in the first and second embodiments in that the attachment portions 83 have a function for adjusting the mounting position of the package-chamber cover 7 in the body space 82, together with the attachment portions 71 of the package-chamber cover 7. Except for the attachment portions 83 and the size of the body space 82, the structure of the body 8 is the same as that of the body 5 in the first and second embodiments.

The attachment portions 71, 83 serve as a mounting position adjustment portion for adjusting the mounting position of the package-chamber cover 7 in the body space 82 as described above. The attachment portions 71, 83 have a function for adjusting the mounting position in the front-rear direction of the package-chamber cover 7, in the body space 82, for example. In this case, the attachment portions 71, 83 are provided at positions opposed to each other in the left-right direction in a state in which the package-chamber cover 7 and the body cover 81 are attached to each other. Either the attachment portion 71 or the attachment portion 83 is formed in a projection shape (protrusion shape), and the other attachment portion is formed in a recess shape. By the projection shape and the recess shape being engaged with each other, the package-chamber cover 7 is held so as not to come off downward from the body cover 81. The recess shape extends in the front-rear direction (mounting position adjustment direction). By the projection shape moving in the front-rear direction in a state of being engaged with the recess shape, the mounting position in the front-rear direction of the package-chamber cover 7 is changed while the package-chamber cover 7 is held by the body cover 81.

In the example in FIG. 25, the attachment portion 71 of the package-chamber cover 7 is formed in a projection shape, and the attachment portion 83 of the body cover 81 is formed in a recess shape. However, the attachment portion 71 may be formed in a recess shape and the attachment portion 83 may be formed in a projection shape. In this embodiment, the attachment portions 71, 83 are provided at four locations in total, i.e., two locations on the front and rear sides at the left surface and two locations on the front and rear sides at the right surface. However, the attachment portions 71, 83 may be provided at any number of locations.

As in the first and second embodiments, the engagement state between the attachment portions 71, 83 is released when a predetermined release operation is performed.

The battery tray 9 is provided so as to be attachable and detachable to and from the upper surface of the package-chamber cover 7. The battery tray 9 includes a placement portion 91 on which the battery body 41 of the battery 4 is to be placed, and a connector holder 92 (holding portion) for holding the connector 43 (first connector) of the battery 4. The placement portion 91 is formed in a flat-plate shape, for example. An upper surface of the placement portion 91 is formed as a horizontal surface, and forms a placement surface for the battery body 41. The connector holder 92 is provided on the upper surface of the placement portion 91 integrally with the placement portion 91.

The shape of the connector holder 92 is the same as that of the connector holder 38 (see FIGS. 2 and 4) in the first and second embodiments.

The battery tray 9 is provided such that the mounting position thereof on the upper surface of the package-chamber cover 7 can be adjusted. Specifically, the mounting position of the battery tray 9 on the upper surface of the package-chamber cover 7 is adjusted such that, in a state in which the package-chamber cover 7 is attached to the body cover 81, the connector holder 92 is located at a position opposed to a connector 84 (second connector) provided to the body cover 81. In the state in which the package-chamber cover 7 is attached to the body cover 81, the connector 43 of the battery 4 held by the connector holder 92 is connected to the connector 84 on the body 8 side. The battery tray 9 serves as a connector position adjustment portion for adjusting the position of the connector holder 92 (i.e., connector 43 of battery 4) on the upper surface of the package chamber 15 so as to be a position opposed to the connector 84 on the body 8 side, irrespective of the mounting position of the package chamber 15 in the body 8. The connector holder 92 is configured as a connector holder of which the mounting position on the upper surface of the package chamber 15 can be adjusted.

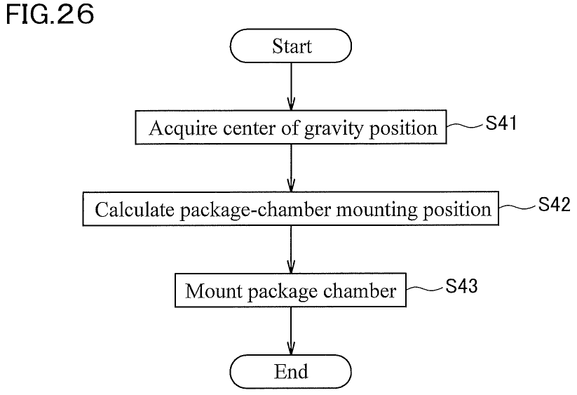

In this embodiment, as step S17 in FIG. 16, a process in FIG. 26 is executed instead of or in addition to the process in FIG. 21, or instead of or in addition to the process in FIG. 23. In addition, the port 500 in this embodiment has the electric configuration shown in FIG. 15, as in the first and second embodiments. In this embodiment, the port 500 includes the package-chamber position adjustment device 217 but may not include the battery position adjustment device 215 and the package position adjustment device 216. The matters other than the configuration of the aerial vehicle 6, the process in FIG. 26, and the package-chamber position adjustment device 217 are the same as in the first and second embodiments.

The package-chamber position adjustment device 217 is a device (robot) that, while attaching the package chamber 15 to the body cover 81, adjusts the attachment positions of the attachment portions 71, 83, thereby adjusting the mounting position of the package chamber 15 in the body space 82. In addition, the package-chamber position adjustment device 217 includes a battery-tray position adjustment device 217a. The battery-tray position adjustment device 217a is a device (robot) that, while keeping a relative positional relationship between the battery body 41 and the package chamber 15, adjusts the mounting position of the battery tray 9 on the upper surface of the package chamber 15 (i.e., the mounting position of the battery body 41 on the battery tray 9).

Hereinafter, the process in FIG. 26 will be described. The process in FIG. 26 is executed by the control device 220 in FIG. 15, for example. In this embodiment, at the time of performing the process in FIG. 26, the package 100 may or may not be left on the package-chamber tray 2. In addition, at the time of performing the process in FIG. 26, the package 110 (see FIGS. 17 to 19) may or may not be newly mounted on the package-chamber tray 2.

In the process in FIG. 26, first, the center of gravity position of the aerial vehicle 6 after package receiving/passing, i.e., the aerial vehicle 6 after the package 100, 110 is received/passed between the package-chamber tray 2 and the package locker 510 in step S15, is acquired (S41). Specifically, the control device 220 causes the center of gravity position acquisition portion 214 in FIG. 15 to measure or calculate the center of gravity position in the horizontal direction of the aerial vehicle 6 after package receiving/passing, and acquires the center of gravity position from the center of gravity position acquisition portion 214. At this time, the center of gravity position acquisition portion 214 may acquire, as the center of gravity position, the weight distribution in the horizontal direction of the package-chamber tray 2 (in a case where the package 100, 110 is placed, including the package 100, 110) in a state of being separated from the package-chamber cover 7, may acquire the weight distribution in the horizontal direction of an integrated unit of the package-chamber tray 2 and the package-chamber cover 7 (in a case where the package 100, 110 is placed, including the package 100, 110), or may acquire the weight distribution in the horizontal direction of an integrated unit of the package chamber 15 and the body 8 (in a case where the package 100, 110 is placed, including the package 100, 110). The center of gravity position acquisition portion 214 may acquire, as the center of gravity position, the weight distribution in the horizontal direction of the package chamber 15 at which the battery 4 is placed (in a case where the package 100, 110 is placed, including the package 100, 110), or may acquire the weight distribution in the horizontal direction of an integrated unit of the body 8 and the package chamber 15 at which the battery 4 is placed (in a case where the package 100, 110 is placed, including the package 100, 110).

In step S41, in a case where the package 100, 110 is placed on the package-chamber tray 2, the center of gravity position of the aerial vehicle 6 may be acquired in a state in which the mounting position of the package 100, 110 on the package-chamber tray 2 is kept at the original position (the mounting position at the time of landing in step S11 or the position of the package 110 on the package-chamber tray 2 when the package 110 has been moved from the package locker 510 onto the package-chamber tray 2 in step S15), or if the mounting position of the package 100, 110 is changed from the original position, the center of gravity position of the aerial vehicle 6 may be acquired in a state after the position change. In step S41, in a case where no package 100, 110 is placed on the package-chamber tray 2, the center of gravity position (weight distribution) of the aerial vehicle 6 is acquired in a state in which there is no package 100, 110. In step S41, the center of gravity position of the aerial vehicle 6 may be acquired in a state in which the mounting position of the battery 4 on the package chamber 15 is kept at the original position (mounting position at the time of landing in step S11), or if the mounting position of the battery 4 is changed from the original position, the center of gravity position of the aerial vehicle 6 may be acquired in a state after the position change.

Next, the control device 220 calculates an optimum mounting position of the package chamber 15 in the body space 82 on the basis of the center of gravity position acquired in step S41 (S42). Specifically, for example, such a mounting position of the package chamber 15 in the body space 82 that the center of gravity position acquired in step S41 coincides with a predetermined target center of gravity position in the body space 82, is calculated as the optimum mounting position.

For example, in FIG. 24, the center of gravity position acquired in step S41 is a position denoted by a reference character “401”. The target center of gravity position is a position denoted by a reference character “400”. In this case, such a package-chamber mounting position 410 that the center of gravity position 401 coincides with the target center of gravity position 400 is calculated as the optimum mounting position.

Here, the center of gravity position (weight distribution) acquired in step S41 changes in accordance with the weight of each package 100 left on the package-chamber tray 2 or each package 110 newly mounted thereon, the mounting position of each package 100, 110 on the package-chamber tray 2, the weight of the battery 4 mounted to the package chamber 15, and the mounting position of the battery 4 on the upper surface of the package chamber 15. Therefore, the optimum mounting position acquired in step S42 changes in accordance with the weight of each package 100, 110 placed on the package-chamber tray 2, the mounting position of each package 100, 110 on the package-chamber tray 2, the weight of the battery 4, and the mounting position of the battery 4. That is, the processing in step S42 is the same as processing of calculating the optimum mounting position of the package chamber 15 on the basis of the weight of each package 100, 110, the mounting position of each package 100, 110, the weight of the battery 4, and the mounting position of the battery 4.

Next, the control device 220 causes the package-chamber position adjustment device 217 in FIG. 15 to, while mounting the package chamber 15 to the body 8, adjust the mounting position of the package chamber 15 in the body space 82 to the optimum mounting position calculated in step S42 (S43). At this time, the battery-tray position adjustment device 217a adjusts the mounting position of the battery tray 9 on the upper surface of the package chamber 15 (i.e., the mounting position of the battery body 41 on the battery tray 9) such that the connector holder 92 (connector 43 of battery 4) comes to a position opposed to the connector 84 on the body 8 side, while keeping a relative positional relationship between the battery body 41 and the package chamber 15 in a state when the optimum mounting position is calculated in step S42 (e.g., the original state when the aerial vehicle 6 has arrived at the port 500). Thus, irrespective of the mounting position of the package chamber 15 in the body space 82, the connector 43 of the battery 4 and the connector 84 on the body 8 side can be connected. As a premise for step S43, the control device 220 causes the package-chamber-tray attachment/detachment device 212 in FIG. 15 to attach the package-chamber tray 2 having returned from the lower space 513 in step S16 in FIG. 16, to the package-chamber cover 7.

As described above, in this embodiment, the mounting position of the package chamber 15 in the body 8 is adjusted after package receiving/passing, whereby the center of gravity position of the aerial vehicle 6 after package receiving/passing can be set at an optimum position. Thus, the same effects as in the first and second embodiments can be obtained.

The package-chamber position adjustment device 217 and the control device 220 for executing steps S41 to S43 in FIG. 26 correspond to a center of gravity adjustment portion and a package chamber position adjustment portion in this disclosure. Steps S41 to S43 correspond to a center of gravity adjustment step.

This disclosure is not limited to the above embodiments and may be modified variously. For example, in the above embodiments, the steps in FIG. 16 are automatically performed, but at least one of the steps may be performed by a human.

For example, a human may perform attachment and detachment of the package-chamber tray to and from the aerial vehicle. In addition, a human may perform correction for the battery-mounting position in step S24 in FIG. 21. In this case, for example, the optimum mounting position obtained through steps S21 to S23 in FIG. 21 may be outputted by means such as display on a display device, and a human may perform correction for the battery-mounting position on the basis of the outputted optimum mounting position. Also, a human may perform step S25 (attachment between the package chamber and the body cover after correction for the battery-mounting position) in FIG. 21.

A human may perform correction for the package mounting position in step S35 in FIG. 23. In this case, the optimum mounting position obtained through steps S31 to S34 in FIG. 23 may be outputted by means such as display on a display device, and a human may perform correction for the package mounting position on the package-chamber tray on the basis of the outputted optimum mounting position. Also, a human may perform step S36 in FIG. 23.

A human may perform correction for the package-chamber mounting position in step S43 in FIG. 26. In this case, the optimum mounting position obtained through steps S41 and S42 in FIG. 26 may be outputted by means such as display on a display device, and a human may perform mounting of the package chamber to the body on the basis of the outputted optimum mounting position.

In the first to third embodiments, a plurality of package moving portions for moving packages between the elevating/lowering portion and the package lockers are provided along the arrangement direction of the packages. However, without limitation thereto, one package moving portion may be moved within the surface of the elevating/lowering portion in accordance with the position of the receiving-target or passing-target package, whereby one or a plurality of packages may be moved (pushed out or drawn) individually by the one package moving portion. The package moving portion may be formed by a belt conveyor, a roller conveyor, or the like.

In the above embodiments, the body cover of the unmanned aerial vehicle is formed in a box shape having an opening on the lower side. However, the body of the unmanned aerial vehicle may have any shape that allows attachment and detachment to and from the package chamber and can ensure a waterproof structure for the battery placed on the package chamber.

In the case of correcting the mounting position of the battery after package receiving or package passing, the battery may be mounted to the aerial vehicle in any manner as long as the mounting position of the battery can be adjusted. In the case of correcting the mounting position of the package chamber after package receiving or package passing, the package chamber may be mounted to the aerial vehicle in any manner as long as the mounting position of the package chamber can be adjusted.

In the above embodiments, the package-chamber tray is placed on the elevating/lowering portion. However, without placing the package-chamber tray on the elevating/lowering portion, the receiving-target or passing-target package may be directly placed on the elevating/lowering portion.

In the above embodiments, the package lockers (package storage portions) are located on a floor lower than the carry-in/out chamber (i.e., takeoff/landing portion). However, the package lockers may be located on a floor higher than the carry-in/out chamber (i.e., takeoff/landing portion). In this case, in step S14 in FIG. 16, the elevating/lowering portion may be elevated, and in step S16, the elevating/lowering portion may be lowered. The package lockers (package storage portions) may be located on the same floor (at the same height position) as the carry-in/out chamber (i.e., takeoff/landing portion). In this case, a horizontal movement portion may be provided instead of the elevating/lowering portion, and in step S14 in FIG. 16, the horizontal movement portion may be moved in the horizontal direction to a position opposed to the package locker, in a state in which the package-chamber tray is placed on the horizontal movement portion. In addition, in step S16 in FIG. 16, the horizontal movement portion may be moved in the horizontal direction to the position of the unmanned aerial vehicle.

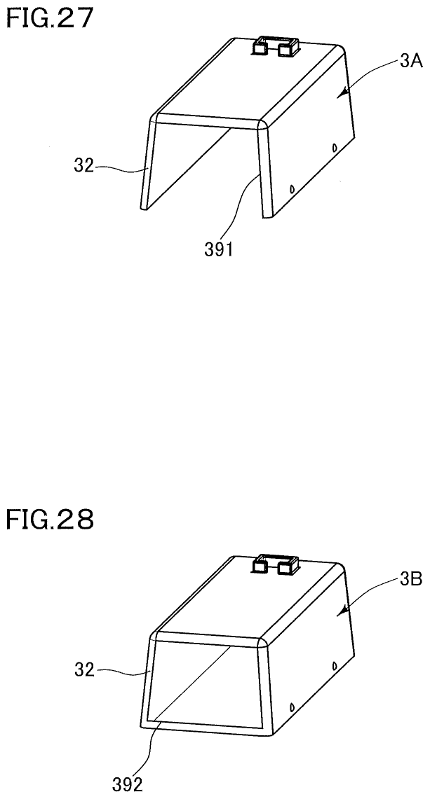

In the above embodiments, the package-chamber tray is attached to the package-chamber cover from below and is detached downward from the package-chamber cover. However, without limitation thereto, for example, as shown in FIGS. 27 and 28, a side-surface opening 391, 392 communicating with an internal space (package-chamber space) of a package-chamber cover 3A, 3B is provided at a side-surface portion 32 of a package-chamber cover 3A, 3B. Then, through the side-surface opening 391, 392, a package-chamber tray may be slid from a lateral side (sideways), to be attached to the package-chamber cover 3A, 3B, and may be slid to the lateral side (sideways), to be detached from the package-chamber cover 3A, 3B. The side-surface opening 391 shown in FIG. 27 is a cutout formed by cutting out a lower end of the package-chamber cover 3A. That is, the side-surface opening 391 is formed in a shape opened on the lower side. The side-surface opening 392 shown in FIG. 28 is a hole formed with a distance provided from the lower end of the package-chamber cover 3B. That is, the side-surface opening 392 is formed in a shape closed on the lower side. The package-chamber cover 3A, 3B is formed in the same manner as the package-chamber cover 3 in the first embodiment or the package-chamber cover 7 in the third embodiment except that the side-surface opening 391, 392 is formed at the side-surface portion 32. In FIGS. 27 and 28, the side-surface opening 391, 392 is formed at the side-surface portion 32 on the front side of the package-chamber cover 3A, 3B, but may be formed at the side-surface portion 32 on the left, right, or rear side. The package-chamber cover 3A, 3B may have a lid for closing the side-surface opening 391, 392. Thus, in a state in which the lid is opened (the side-surface opening 391, 392 is exposed), the package-chamber tray is attached and detached to and from the package-chamber cover 3A, 3B through the side-surface opening 391, 392, and by closing the lid in a state in which the package-chamber tray is attached to the package-chamber cover 3A, 3B, a foreign material such as water can be prevented from entering the inside of the package chamber from the lateral side. The package-chamber cover 3A, 3B may have a bottom-surface portion closing the internal space. Thus, a foreign material such as water can be further prevented from entering the inside of the package-chamber cover 3A, 3B from below.

In the third embodiment, the battery body is placed above the package-chamber upper surface with the battery tray interposed therebetween. However, as long as the position of the connector holder for holding the connector of the battery can be adjusted, the battery body may be directly mounted on the package-chamber upper surface. That is, in FIG. 25, of the battery tray 9, the part 91 on which the battery body 41 is to be placed may not be provided.

In the above embodiments, the center of gravity position of the unmanned aerial vehicle is adjusted after package receiving/passing. However, a configuration in which adjustment of the center of gravity position is not performed may be employed.

That is, a package receiving or passing apparatus of this disclosure may be configured as a package receiving or passing apparatus including:
a landing portion on which an unmanned aerial vehicle allowing a plurality of packages to be mounted thereto lands;
a package storage portion;
a package-placing portion on which the package taken down from the unmanned aerial vehicle or the package stored in the package storage portion is to be placed, the package-placing portion allowing a plurality of the packages to be placed thereon,
a movement control portion configured to move the package-placing portion between a position of the unmanned aerial vehicle and a position opposed to the package storage portion, and
a package moving portion configured to, at the opposed position, move the package placed on the package-placing portion to the package storage portion or move the package stored in the package storage portion to the package-placing portion, the package moving portion being capable of, in a case where a plurality of the packages are placed on the package-placing portion or a plurality of the packages are stored in the package storage portion, moving each package individually.

In this case, a plurality of the package moving portions may be provided to the package-placing portion, along an arrangement direction of the packages on the package-placing portion or in the package storage portion.

Thus, receiving/passing of a plurality of packages or receiving/passing of at least one of a plurality of packages can be efficiently performed between the unmanned aerial vehicle and the port.

### DESCRIPTION OF THE REFERENCE CHARACTERS

1, 6 unmanned aerial vehicle
2 package-chamber tray
3, 3A, 3B, 7 package-chamber cover
4 battery
5, 8 body of unmanned aerial vehicle
10, 15 package chamber
100, 110 package
500 aerial-vehicle port
501 takeoff/landing portion
510 package locker (package storage portion)
506 elevating/lowering portion
507 package moving portion
220 control device
215 battery position adjustment device
216 package position adjustment device
217 package-chamber position adjustment device

What is claimed is:

1. A package receiving or passing apparatus comprising:
a landing portion on which an unmanned aerial vehicle lands;
a package storage portion;
a conveyance portion configured to convey a package from the unmanned aerial vehicle landed on the landing portion to the package storage portion, or from the package storage portion to the unmanned aerial vehicle;
a center of gravity adjustment portion configured to adjust a center of gravity position of the unmanned aerial vehicle after receiving/passing of the package; and
a takeoff portion from which the unmanned aerial vehicle with the center of gravity position adjusted takes off.

2. The package receiving or passing apparatus according to claim 1, wherein the center of gravity adjustment portion includes a battery position adjustment portion configured to adjust a mounting position of a battery that is mounted to the unmanned aerial vehicle.

3. The package receiving or passing apparatus according to claim 1, wherein the center of gravity adjustment portion includes a package position adjustment portion configured to adjust a mounting position, in the unmanned aerial vehicle, of the package left in the unmanned aerial vehicle or the package newly mounted to the unmanned aerial vehicle.

4. The package receiving or passing apparatus according to claim 1, wherein
the unmanned aerial vehicle includes a package chamber configured to house the package therein, and a body to which the package chamber is attached and which is capable of flying, and
the center of gravity adjustment portion includes a package chamber position adjustment portion configured to adjust a mounting position of the package chamber in the body.

5. The package receiving or passing apparatus according to claim 1, wherein
the conveyance portion includes
a package-placing portion on which the package taken down from the unmanned aerial vehicle or the package stored in the package storage portion is to be placed,
a movement control portion configured to move the package-placing portion between a position of the unmanned aerial vehicle and a position opposed to the package storage portion, and
a package moving portion configured to, at the opposed position, move the package placed on the package-placing portion to the package storage portion or move the package stored in the package storage portion to the package-placing portion, the package moving portion being capable of, in a case where a plurality of the packages are placed on the package-placing portion or a plurality of the packages are stored in the package storage portion, moving each package individually.

6. The package receiving or passing apparatus according to claim 5, wherein
a plurality of the package moving portions are provided to the package-placing portion, along an arrangement direction of the packages on the package-placing portion or in the package storage portion.

7. The package receiving or passing apparatus according to claim 5, wherein
the unmanned aerial vehicle includes a placement portion on which the package is to be placed,
the placement portion taken down from the unmanned aerial vehicle is to be placed on the package-placing portion,
the movement control portion includes
a first movement control portion configured to move the package-placing portion on which the placement portion is placed, to the position opposed to the package storage portion, and
a second movement control portion configured to move the package-placing portion on which the placement portion is placed, to the position of the unmanned aerial vehicle, after passing/receiving of the package is performed from the placement portion to the package storage portion or from the package storage portion to the placement portion, and
the unmanned aerial vehicle to which the placement portion having returned by the second movement control portion is mounted again takes off from the takeoff portion.

8. The package receiving or passing apparatus according to claim 1, wherein
the landing portion is provided in an outdoor area,
the package receiving or passing apparatus further comprises a horizontal movement portion configured to horizontally move the unmanned aerial vehicle landed on the landing portion to an indoor area adjacent to the landing portion, and
the conveyance portion conveys the package between the package storage portion and the unmanned aerial vehicle moved into the indoor area.

9. A package receiving or passing method comprising:
a package receiving or passing step of receiving a package mounted to a landed unmanned aerial vehicle or passing a package to the unmanned aerial vehicle;
a center of gravity adjustment step of adjusting, before takeoff, a center of gravity position of the unmanned aerial vehicle after the package receiving or passing step; and
a takeoff step of causing the unmanned aerial vehicle with the center of gravity position adjusted, to take off.

10. The package receiving or passing method according to claim 9, wherein
a placement portion on which a package is to be placed is mounted to the unmanned aerial vehicle,
the package receiving or passing step includes
a first conveyance step of performing control to convey the placement portion taken down from the unmanned aerial vehicle, to a position opposed to a package storage portion,
a package movement step of, at the opposed position, moving the package placed on the placement portion individually to the package storage portion or moving the package stored in the package storage portion individually to the placement portion, and
a second conveyance step of performing control to convey the placement portion to the unmanned aerial vehicle after the package movement step, and
in the takeoff step, the unmanned aerial vehicle to which the placement portion having returned in the second conveyance step is mounted again, is caused to take off.
